(19) United States
(12) Patent Application Publication
(10) Pub. No.: US 2016/0273741 A1
(43) Pub. Date: Sep. 22, 2016

(54) LIGHT MODULE, ILLUMINATION APPARATUS COMPRISING ONE-BODY TYPE MOLDING SUBSTRATE, AND METHOD FOR FABRICATING THE LIGHT MODULE

(71) Applicant: Suk-ho JUNG, Hwaseong-si (KR)

(72) Inventor: Suk-ho JUNG, Hwaseong-si (KR)

(21) Appl. No.: 14/959,012

(22) Filed: Dec. 4, 2015

(30) Foreign Application Priority Data
Mar. 20, 2015 (KR) 10-2015-0039024

(51) Int. Cl. F21V 19/00; F21V 9/00; F21V 3/02; F21V 29/74; F21V 7/04

(52) U.S. Cl. CPC F21V 19/002; F21V 29/74; F21V 7/04; F21V 3/02; F21V 9/00

(57) ABSTRACT

A light source module in an illumination apparatus includes an integrally molded substrate and at least one light emitting diode (LED) chip mounted on the mounting region of the substrate portion. The integrally molded substrate includes a substrate portion including a mounting region and a holder portion integrally provided with the substrate portion. The holder portion covers at least a portion of a top surface of the substrate portion to expose the mounting region and includes a reflective surface that is positioned adjacent to the mounting region.

### CROSS-REFERENCE TO RELATED APPLICATION

This application claims priority from Korean Patent Application No. 10-2015-0039024, filed on Mar. 20, 2015, in the Korean Intellectual Property Office, the disclosure of which is incorporated herein in its entirety by reference.

### BACKGROUND

1. Field

Apparatuses and methods consistent with exemplary embodiments relate to a semiconductor light-emitting device, and more particularly, to a substrate for mounting a semiconductor light-emitting device, a light source module including the substrate, an illumination apparatus including the light source module, and a method of fabricating the light source module.

2. Description of the Related Art

Generally, a power supply for a printed circuit board (PCB) used in a light-emitting diode (LED) illumination apparatus is required to have excellent reliability, high heat radiating efficiency, and excellent electric conductivity. Currently, PCBs widely used for chip-on-boards (COBs) comprise a ceramic material or a metal. Due to the relatively high heat resistance, a ceramic substrate does not easily deform at a high temperature. A metal substrate exhibits excellent heat radiating efficiency and high mechanical strength, but also exhibits substantial thermal contraction and expansion and an insulating operation is required to insulate the metal substrate. Generally, a high power LED device with an output from 1 W to 4 W emits a large amount of heat. Therefore, if a PCB with insufficient heat radiating efficiency is used for a high power LED device, the illuminance of an LED may rapidly drop or a color rendering index (CRI) and a color temperature may shift. Therefore, a PCB for a high power LED device generally comprises a metal, e.g., aluminum (Al). An Al-based PCB exhibits superior heat radiating efficiency than an epoxy (e.g., FR4) based PCB or a ceramic-based PCB. However, the Al-based PCB is relatively expensive and also requires an insulating operation.

### SUMMARY

One or more exemplary embodiments provide a light source module including a substrate capable of substantially reducing material cost and operation cost for embodying a chip-on-board (COB)-type light source module by using a metal-based substrate, an illumination apparatus including the light source module, and a method of fabricating the light source module.

According to an aspect of an exemplary embodiment, there is provided a light source module for use in an illumination apparatus, the light source module including: an integrally molded substrate including: a substrate portion including a mounting region; and a holder portion integrally provided with the substrate portion, wherein the holder portion covers at least a portion of a top surface of the substrate portion to expose the mounting region and includes a reflective surface that is positioned adjacent to the mounting region; and at least one light emitting diode (LED) chip mounted on the mounting region of the substrate portion.

According to an aspect of another exemplary embodiment, there is provided an illumination apparatus including: an integrally molded substrate including: a substrate portion including a mounting region; and a holder portion integrally provided with the substrate portion, wherein the holder portion covers at least a portion of a top surface of the substrate portion to expose the mounting region and includes a reflective surface at a side portion, the side portion being positioned adjacent to the mounting region; at least one light emitting diode (LED) chip mounted on the mounting region; an optical component arranged above the mounting region; and a heat radiator coupled to a bottom portion of the integrally molded substrate.

According to an aspect of still another exemplary embodiment, there is provided an illumination apparatus including: an integrally molded substrate including: a substrate portion including a mounting region; and a holder portion integrally provided with the substrate portion, wherein the holder portion covers at least a portion of a top surface of the substrate portion to expose the mounting region, the holder portion including a reflective surface at a side portion, the side portion being positioned adjacent to the mounting region, and a connector electrically connected to wirings of the substrate portion; at least one light emitting diode (LED) chip mounted on the mounting region; an optical component arranged above the mounting region; and a housing configured to accommodate the integrally molded substrate, the at least one LED chip, and the optical component.

According to an aspect of still another exemplary embodiment, there is provided a method of fabricating a light source module for use in of an illumination apparatus including: preparing a metal substrate; providing a wiring layer on the metal substrate; integrating the metal substrate and a holder portion with each other via insert molding, such that the holder portion covers at least a portion of the metal substrate to expose a mounting region of the metal substrate and a reflective surface is provided at a side portion of the holder portion, the side portion of the holder portion being disposed adjacent to the mounting region; mounting at least one light emitting diode (LED) chip on the mounting region; and encapsulating the at least one LED chip by using a molding material.

According to an aspect of still another exemplary embodiment, there is provided an integrally molded substrate including a first region on which at least one light emitting diode (LED) chip is mounted and a second region that surrounds the first region, wherein the first region and the second region comprises heterogeneous materials and the first region and the second region are integrally provided via insert molding.

### BRIEF DESCRIPTION OF THE DRAWINGS

The above and/or other aspects will become more apparent by describing certain exemplary embodiments with reference to the accompanying drawings, in which:

FIGS. 1 and 2 are a perspective view and a sectional view of an integrally molded substrate according to an exemplary embodiment, respectively, wherein FIG. 2 is a sectional view along a line I-I′ of FIG. 1;

FIGS. 3A and 3B are perspective view diagrams respectively showing a substrate portion and a holder portion of the integrally molded substrate of FIG. 1, and FIG. 3C is a sectional view of the integrally molded substrate of FIG. 3A along a line II-II′;

FIGS. 4 through 6 are sectional views of integrally molded substrates corresponding to FIG. 2, according to exemplary embodiments;

FIGS. 7 and 8 are perspective views of integrally molded substrates corresponding to FIG. 1, according to exemplary embodiments;

FIGS. 9A and 9B are a perspective view and a sectional view of an integrally molded substrate according to an exemplary embodiment, respectively, wherein FIG. 9B is a sectional view along a line III-III′ of FIG. 9A;

FIGS. 10A and 10B are a perspective view and a sectional view of an integrally molded substrate according to an exemplary embodiment, respectively, wherein FIG. 10B is a sectional view along a line V-V′ of FIG. 10A;

FIG. 11 is a perspective view of an integrally molded substrate according to an exemplary embodiment;

FIGS. 12A and 12B are a perspective view and a sectional view of an integrally molded substrate according to an exemplary embodiment, respectively, wherein FIG. 12B is a sectional view along a line VII-VII′ of FIG. 12A;

FIGS. 13A through 13D are perspective views of integrally molded substrates according to exemplary embodiments;

FIGS. 14A and 14B are a sectional view and an exploded perspective view of an illumination apparatus according to an exemplary embodiment, respectively, and FIGS. 14C and 14D are sectional views of illumination modules employed by the illumination apparatus of FIG. 14A;

FIG. 15A is a graph of CIE color temperatures showing an ideal radial body spectrum, and FIG. 15B is a diagram showing a case in which a defect occurs in an illumination apparatus due to shift of color coordinates;

FIG. 16 is a flowchart of a method of manufacturing a light source module according to an exemplary embodiment;

FIGS. 17A through 17E are sectional views showing operations for manufacturing a light source module corresponding to the flowchart shown in FIG. 16;

FIG. 18 is an exploded perspective view of an illumination apparatus according to an exemplary embodiment;

FIG. 19 is a sectional view of an illumination apparatus according to an exemplary embodiment;

FIGS. 20A and 20B are a perspective view and an exploded perspective view of an illumination apparatus according to an exemplary embodiment, respectively, FIG. 20C is a sectional view of a light source module in the illumination apparatus of FIG. 20A, and FIG. 20D is an example view of the illumination apparatus of FIG. 20A; and

FIGS. 21 and 22 are diagrams showing examples of a home network including an illumination apparatus according to an exemplary embodiment.

### DETAILED DESCRIPTION

Hereinafter, certain exemplary embodiments will be described more fully with reference to the accompanying drawings, in which exemplary embodiments are shown. The exemplary embodiments may, however, be embodied in many different forms and should not be construed as limited to the exemplary embodiments set forth herein. Rather, these exemplary embodiments are provided so that this disclosure will be thorough and complete, and will fully convey the scope of the disclosure to one of ordinary skill in the art.

Hereinafter, if an element is connected to another element, the element may be directly connected to the other element or a third element may be interposed therebetween. Similarly, if an element is arranged on another element, the element may be arranged directly on the other element or a third element may be interposed therebetween. Furthermore, sizes of elements in the drawings may be exaggerated for convenience of explanation and clarity, and those irrelevant to descriptions of the exemplary embodiments are omitted. Like reference numeral denote like elements. As used herein, the term “and/or” includes any and all combinations of one or more of the associated listed items. Expressions such as “at least one of,” when preceding a list of elements, modify the entire list of elements and do not modify the individual elements of the list.

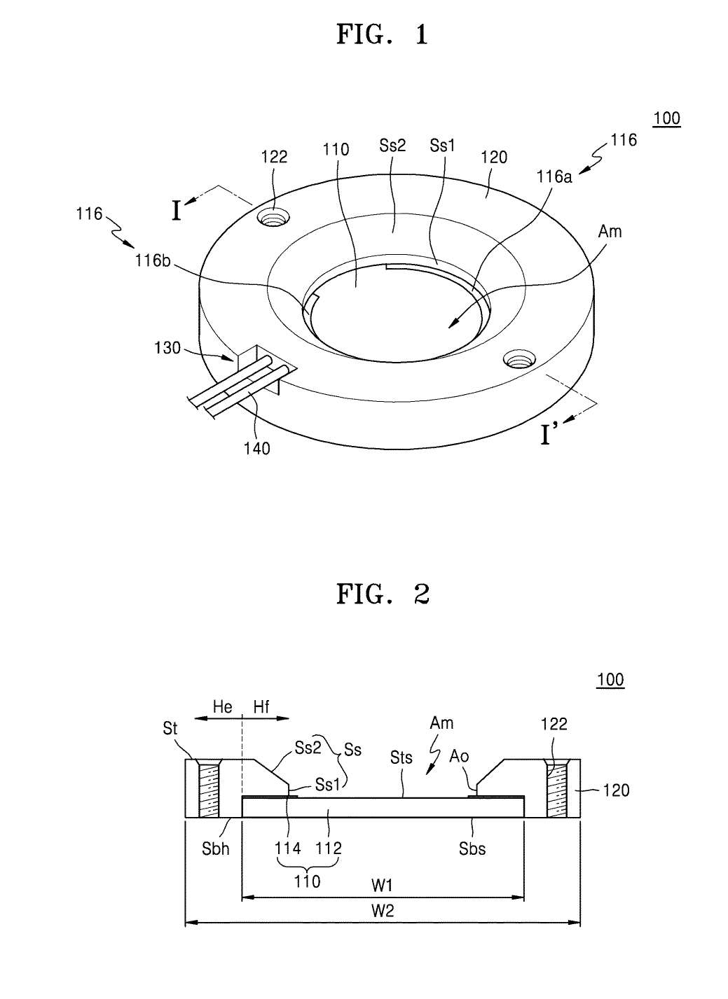

FIGS. 1 and 2 are a perspective view and a sectional view of an integrally molded substrate 100 according to an exemplary embodiment, respectively, wherein FIG. 2 is a sectional view along a line I-I′ of FIG. 1.

Referring to FIGS. 1 and 2, the integrally molded substrate 100 according to the present embodiment may include a substrate portion 110 and a holder portion 120.

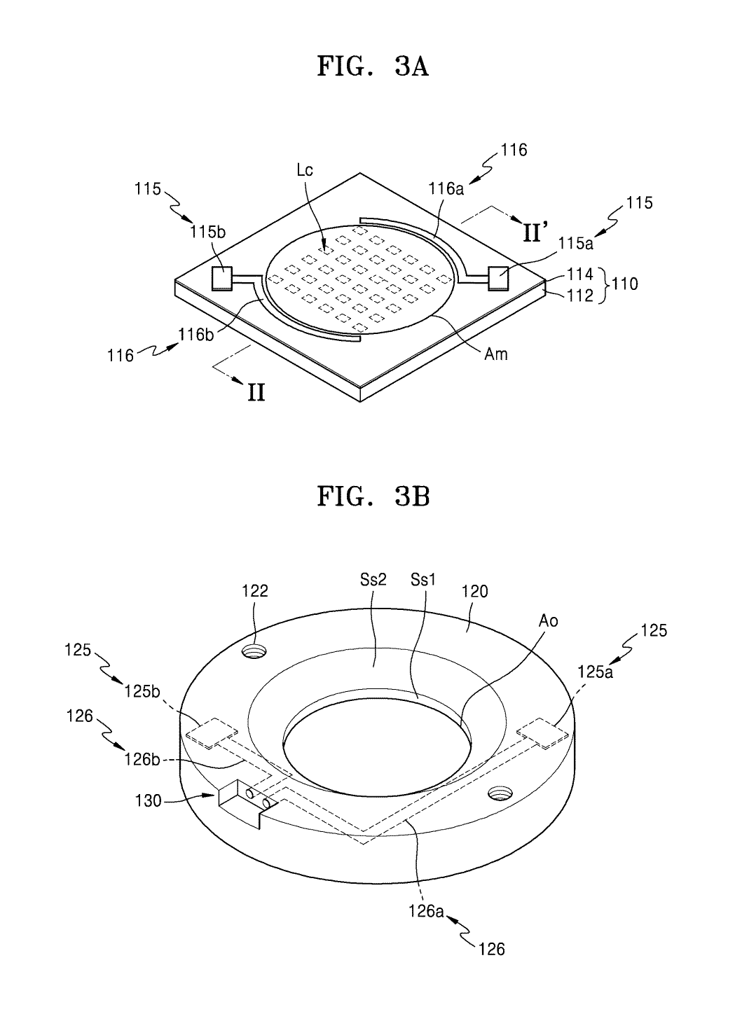

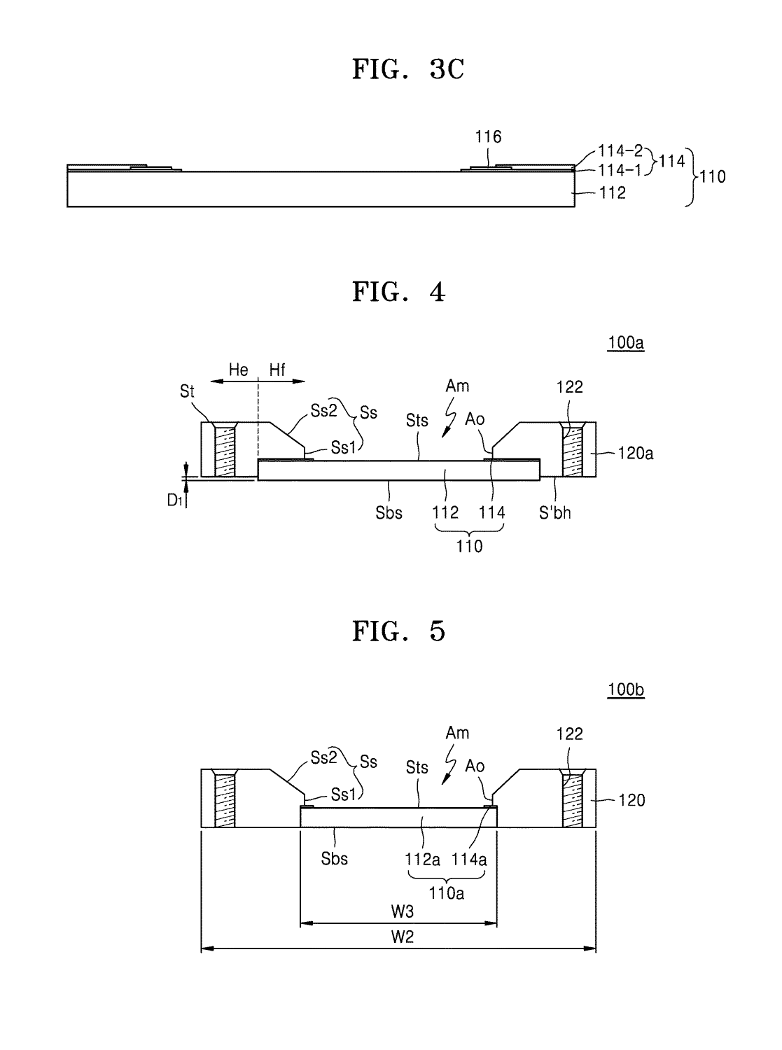

The substrate portion 110 may be a metal-based printed circuit board (PCB). Therefore, the substrate portion 110 may include a metal 112, an insulation layer 114, and wiring layers (115 and 116 of FIG. 3A). For example, the metal layer 112 may be formed of aluminium (Al), copper (Cu), electrolytic galvanized iron (EGI), etc. In the integrally molded substrate 100 according to the present embodiment, the metal layer 112 may be formed of Al. However, materials for forming the metal layer 112 are not limited thereto.

The insulation layer 114 may be formed outside a mounting region Am on the metal layer 112. However, the insulation layer 114 may be formed on the entire top surface of the metal layer 112 including the mounting region Am. Here, the mounting region Am may refer to a region on which light-emitting diode (LED) chips are mounted. The insulation layer 114 may include a lower insulation layer (114-1 of FIG. 3A) and an upper insulation layer (114-2 of FIG. 3A). The lower insulation layer 114-1 may be formed of an epoxy-based material, e.g., FR4. However, materials for forming the lower insulation layer 114-1 are not limited to epoxy-based materials. The upper insulation layer 114-2 may be formed of photo solder resist (PSR). However, materials for forming the upper insulation layer 114-2 are not limited to PSR.

The wiring layers (115 and 116 of FIG. 3A) may be formed of Cu having excellent electric conductivity. However, materials for forming the wiring layers are not limited to Cu. As shown in FIG. 3C, an wiring layer 116, which is one of wiring layers, may be formed on the lower insulation layer 114-1, where a portion of the wiring layer 116 may be covered by the upper insulation layer 114-2 and the other portion of the wiring layer 116 may be exposed. Furthermore, as shown in FIG. 1, the wiring layer 116 may be arranged outside the mounting region Am, and thus the wiring layer 116 may be exposed to outside without being covered by the holder portion 120.

Since the substrate portion 110 is formed based on a metal such as Al, the substrate portion 110 may exhibit an excellent heat radiation characteristic. Furthermore, by forming an insulation layer using an epoxy-based material, such as FR4, an insulation characteristic of the substrate portion 110 may be substantially improved. Furthermore, operations for forming circuit patterns of the inventive concept are identical to operations for forming general PCB circuit patterns, and thus a cost for forming circuit patterns may be substantially reduced. Here, metal-based PCBs may be categorized into a metal PCB (MPCB) and a metal core PCB (MCPCB). In the case of an MCPCB, insulation layers are formed on both surfaces of a metal layer. On the other hand, in the case of an MPCB, an insulation layer may be formed on one surface of a metal layer only. An MCPCB may be used as a double substrate.

A mounting region Am of a top surface Sts of the substrate portion 110 may be highly reflective. However, the inventive concept is not limited thereto, and the entire top surface Sts of the substrate portion 110 may be highly reflective. A high reflection process may be performed by using a highly reflective film formed by depositing a metal with high reflectivity, e.g., Cr, Ag, Pt, Au, etc. via sputtering or may be performed by forming a highly reflective polymer composite on portions of the substrate portion 110 except wiring layers. Via the high reflection process, the top surface Sts of the substrate portion 110 may exhibit 98% or higher reflectivity in the mounting region Am. High reflectivity in a mounting region may contribute to improved brightness of an LED illumination.

The holder portion 120 may attach the substrate portion 110 to a heat radiating unit (or heat radiator) therebelow, such as a heat sink, and may connect wirings of the substrate portion 110 to outside wirings. As shown in FIGS. 1 and 2, the holder portion 120 may be formed to surround side surfaces and a portion of the top surface Sts of the substrate portion 110. The holder portion 120 may be formed of an insulation material, e.g., a plastic resin used for injection molding. For example, the holder portion 120 may be formed of any of various plastic resins, such as polycarbonate (PC), polyphthalamide (PPA), and acrylonitrile-butadiene-styrene (ABS). The substrate portion 110 and the holder portion 120 may be integrally formed via insert injection or insert molding.

Insert molding is a molding method for integrating heterogeneous or heterochromic plastics or integrating plastic parts with non-plastic parts (e.g., a metal part, a cable, a PCB, a magnet, etc.) in a mold to obtain a molded product exhibiting characteristics that may be hardly by forming products of plastics only. The most popular insert molding products are formed by integrating metals with plastics and thus very high value products may be manufactured by combining the hardness, conductivity, and surface workability of metals with the electric insulation, colorablity, flexibility, hardness, and workability of plastics.

The advantages of the insert molding will be briefly described below. First, by combining heterogeneous materials, the strengths of the respective materials may complement one another while the shortcomings may be offset, and thus a highly efficient structure may be obtained. For example, a durable, small, and light weighted part may be obtained by combining the hardness, conductivity, plastic deformability of a metal with the moldability, insulation, and self-lubricativity of a resin. Second, since heterogeneous materials are integrated with one another via molding, a reliable part with high relative position precision and without looseness and separated parts may be manufactured. Third, based on the characteristics of molding, insert molded products may be utilized in various fields, such as electrics and/or electronics areas, automobiles, precision instruments, office machines, and toys, and may contribute to cost reduction, quality and functional improvements, and reduction of production time.

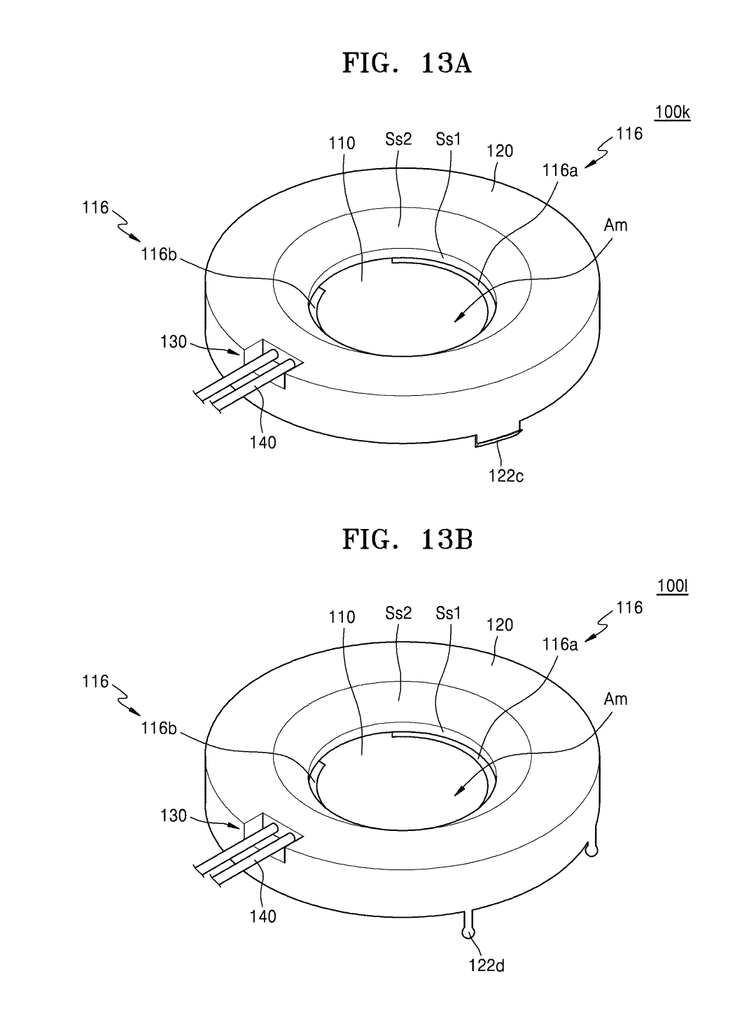

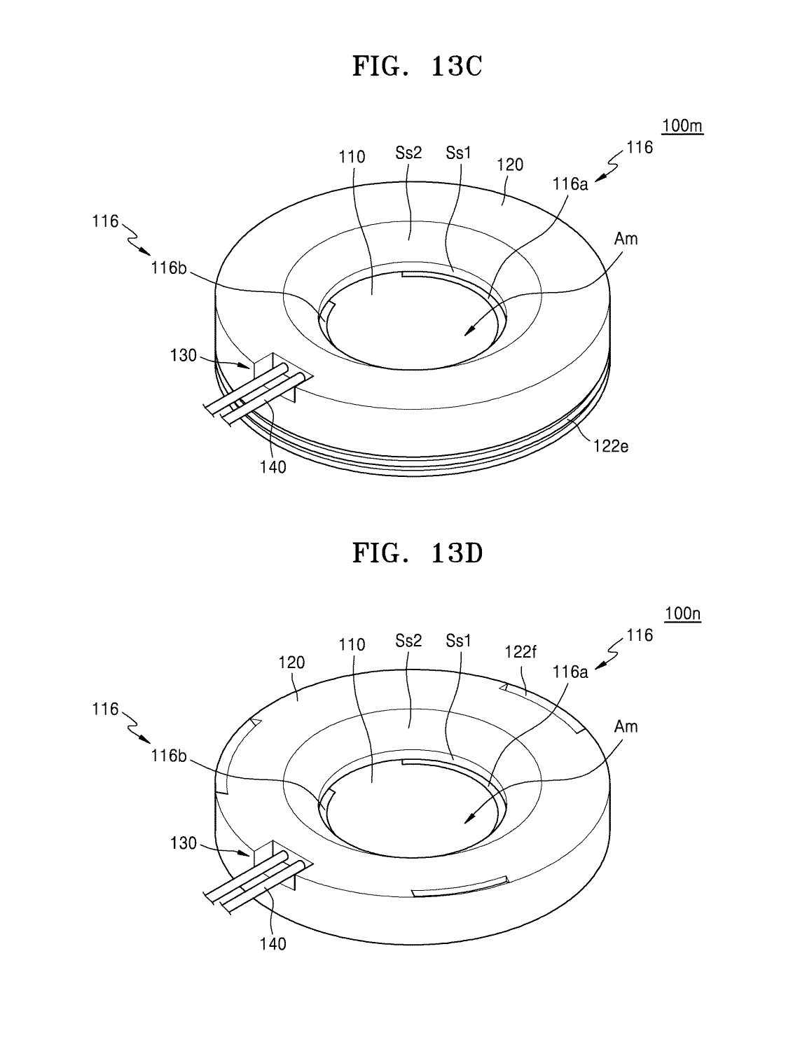

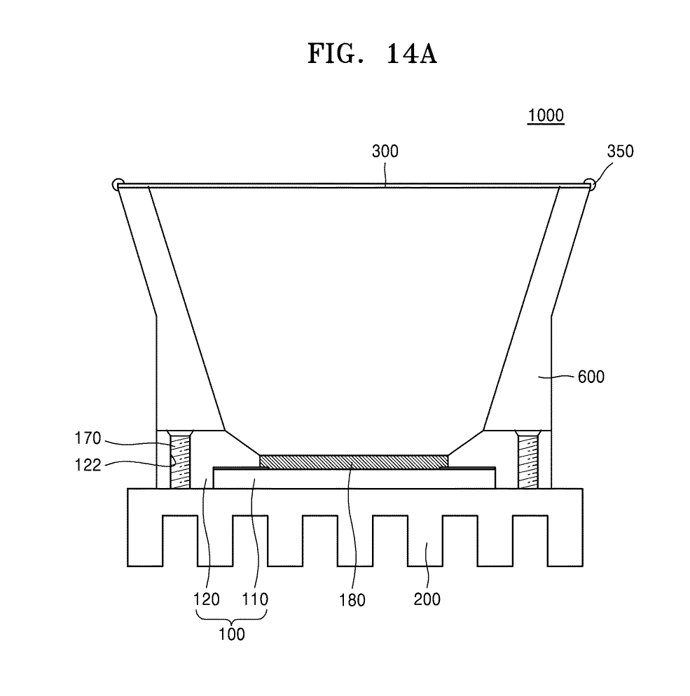

A screw hole 122 for screw attachment may be formed in the holder portion 120. The integrally molded substrate 100 may be screw-attached and fixed to a heat radiating unit, such as a heat sink, via the screw hole 122. Although the two screw holes 122 are formed in the holder portion 120, a number of the screw holes 122 is not limited to two. For example, the three or more screw holes 122 may be formed. Attachment of the holder portion 120 to a heat radiating unit is not limited to screw attachment. For example, the holder portion 120 may be attached to a heat radiating unit via other attachment methods, e.g., hook attachment, snap attachment. Other methods for attaching the holder portion 120 to a heat radiating unit will be described below in detail with reference to FIGS. 13A through 13D.

A connector 130 may be arranged at the holder portion 120. The connector 130 may be electrically connected to wirings (115 and 116 of FIG. 3A) of the substrate portion 110 via wirings (125 and 126 of FIG. 3B). Furthermore, the connector 130 may be electrically connected to a power supply via an external wiring 140. Here, the external wiring 140 is only provided to show a connection thereof to the connector 130, where the external wiring 140 is not included in the integrally molded substrate 100.

The holder portion 120 may include an open region Ao at the center to expose the mounting region Am of the substrate portion 110 as shown in FIGS. 1 and 2. An area of the open region Ao may be identical to or slightly greater than that of the mounting region Am.

The holder portion 120 may be roughly divided into a fence region Hf, which is arranged nearby the mounting region Am and constitutes the open region Ao by partially covering the top surface Sts of the substrate portion 110, and an expanding region He, which extends outward from the fence region Hf and covers side surfaces of the substrate portion 110. The holder portion 120 is divided into the fence region Hf and the expanding region He merely for illustrating a structure of the holder portion 120. There is no physical border between the fence region Hf and the expanding region He.

The fence region Hf includes side surfaces Ss and a top surface St, where the side surfaces Ss may include a first portion Ss1, which is arranged nearby the mounting region Am and is tilted with respect to the top surface Sts of the substrate portion 110 by a relatively large angle, and a second portion Ss2, which is tilted with respect to the top surface Sts of the substrate portion 110 by a relatively small angle. For example, the first portion Ss1 may be perpendicular to or almost perpendicular to the top surface Sts of the substrate portion 110. According to an exemplary embodiment, the side surfaces Ss may include the tilted second portion Ss2 only. At least one of the first portion Ss1 and the second portion Ss2 is a reflective surface and may function as a reflector.

Here, a reflector has a structure to emit light beams emitted by LED chips, light beams modulated by phosphors, or a combination of two or more light beams at an optimal efficiency and may be formed of a material and in a color for achieving high reflectivity by preventing the light beams from being absorbed or transformed into heat. Therefore, the holder portion 120 may be formed to have a suitable structure and a suitable color in consideration of reflector function of the first portion Ss1 and the second portion Ss2. For example, the holder portion 120 may be formed in white for high reflectivity. However, color of the holder portion 120 is not limited to white. Furthermore, a separate optical process, such as high reflection process, may be performed to the first portion Ss1 and the second portion Ss2 of the holder portion 120.

The expanding region He may include a bottom surface Sbh and a top surface St, where the bottom surface Sbh may form a smooth surface with the bottom surface Sbs of the substrate portion 110. The screw hole 122 may be formed in the expanding region He. A screw thread may be or may not be formed on the inner wall of the screw hole 122. Here, since the top surface of the expanding region He and the top surface of the fence region Hf form a same surface, the top surface of the expanding region He and the top surface of the fence region Hf are denoted by the same reference numeral ‘St.’

The substrate portion 110 may have a first width W1, whereas the holder portion 120 may have a second width W2. Since the holder portion 120 is formed to surround side surfaces of the substrate portion 110, the second width W2 of the holder portion 120 may be greater than the first width W1 of the substrate portion 110.

In the integrally molded substrate 100 according to the present embodiment, the substrate portion 110 and the holder portion 120 may be integrated with each other via insert molding. Therefore, the integrally molded substrate 100 according to the present embodiment may have the advantages of insert molded products, e.g., a reasonable structure, high precision, strong attachment, high reliability, reduced cost, and reduced production time, according to a combination of the heterogeneous materials in their structure. Furthermore, the integrally molded substrate 100 according to the present embodiment may be applied to a chip-on-board (COB)-type light source module and an illumination apparatus including the same, thereby embodying a light source module, which corresponds to a standard light source module and exhibits excellent color quality without shifting of the color coordinates, and an illumination apparatus including the same and substantially reducing costs of a light source module and an illumination apparatus including the same. Furthermore, the integrally molded substrate 100 according to the present embodiment may be highly compatible and may be conveniently replaced in a set or an illumination apparatus and may be conveniently replaced. Detailed descriptions thereof will be given below with reference to FIGS. 3A through 3C.

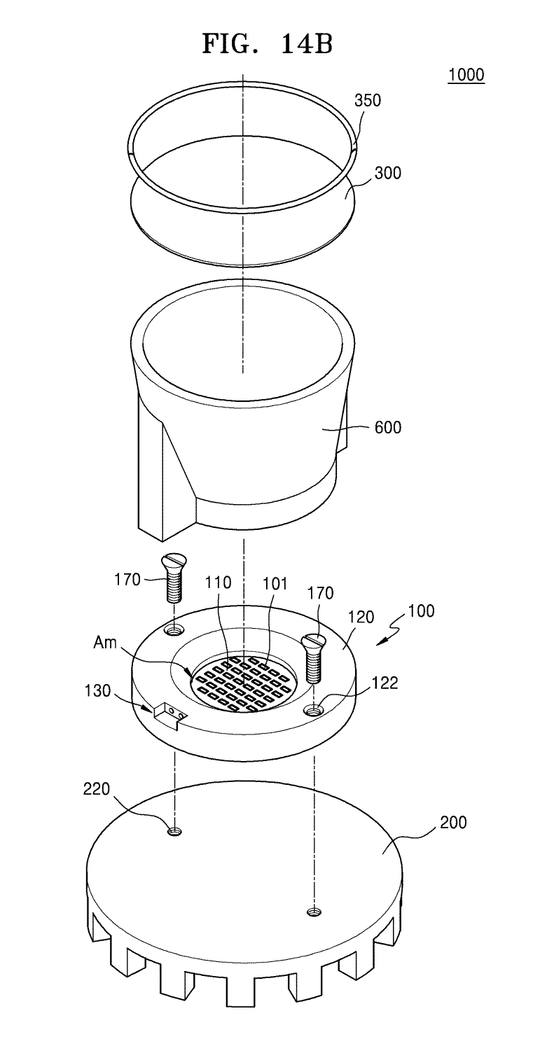

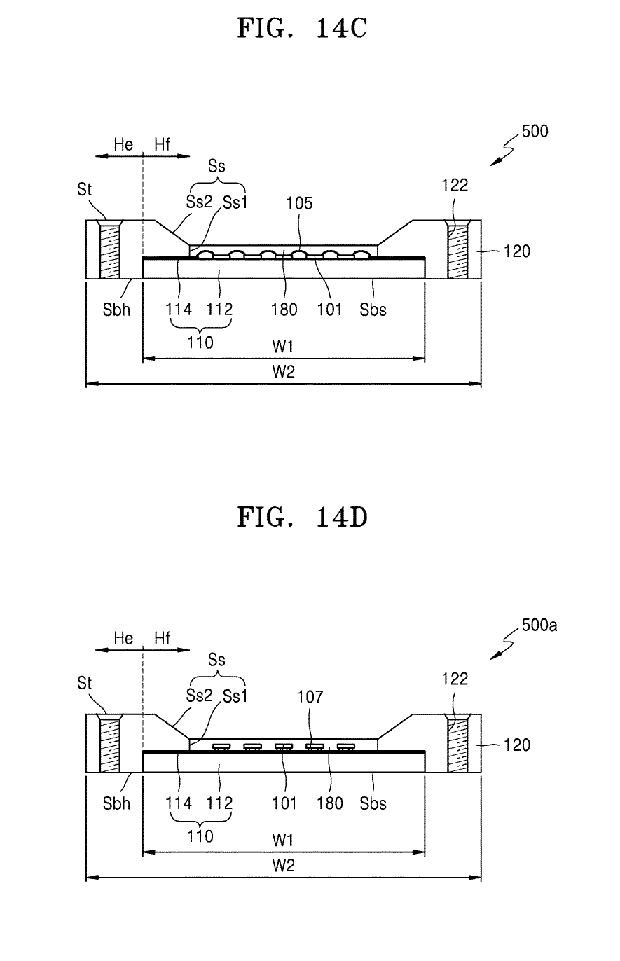

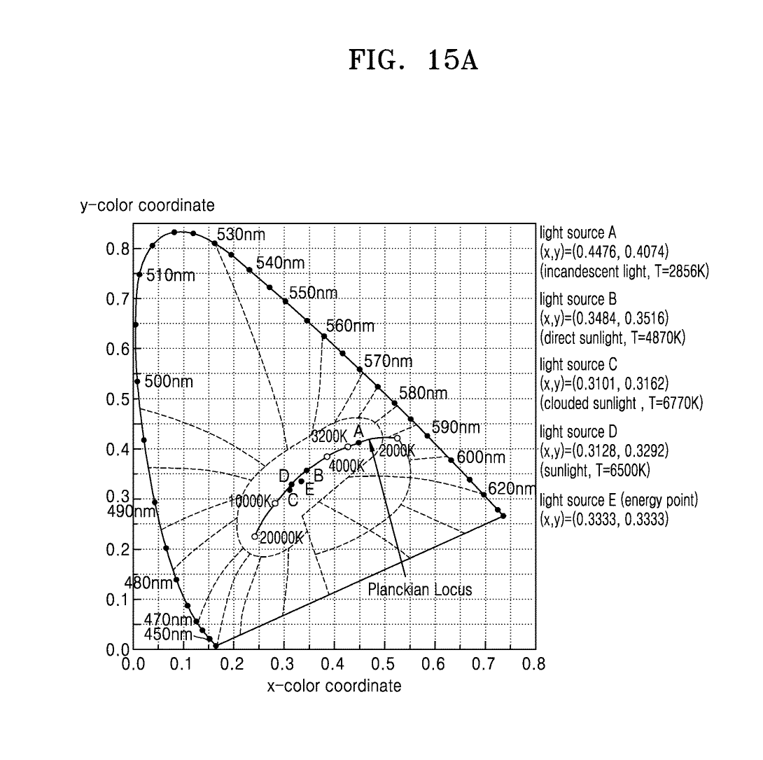

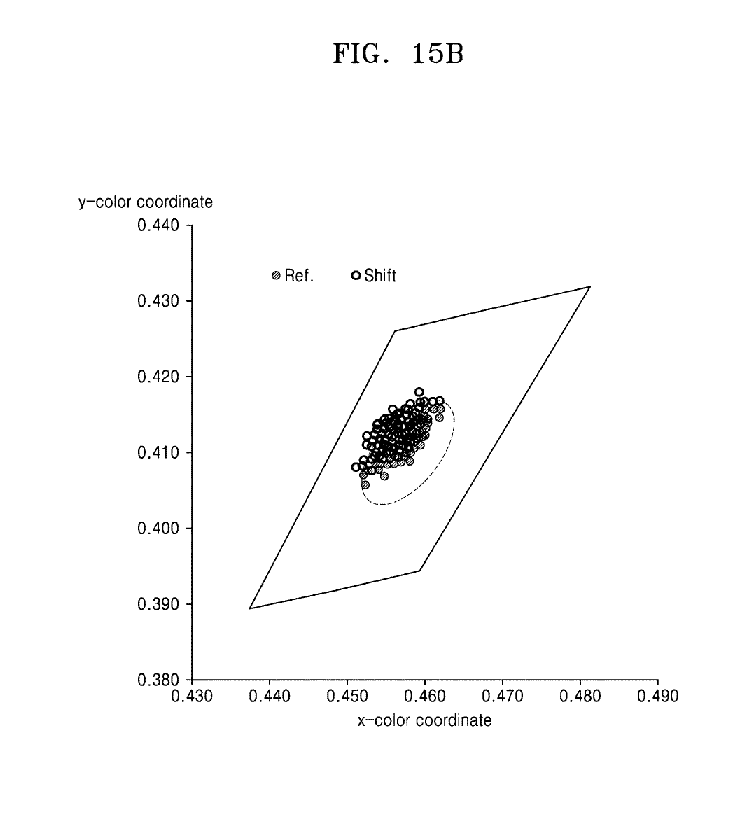

Detailed descriptions of color temperature shift will be given below with reference to FIGS. 14A through 14D and FIGS. 15A and 15B. Although a light source module and an illumination apparatus may be distinguished from each other in various ways, the term “light source module” may refer to a structure formed by mounting LED chips on an integrally molded substrate herein (refer to 500 of FIG. 14C or 500a of FIG. 14D), whereas the term “illumination apparatus” may refer to a structure including all components constituting an illumination apparatus, such as a light source module, a heat sink, an optical unit (or optical component), and a housing. If needed, the term “an illumination engine” or “an illumination system” may be used instead of an illumination apparatus. Furthermore, the term “an LED package” may be used instead of the term “a light source module”. For example, the optical unit may include any component that changes of optical paths of a light beam from an LED chip, e.g., an optical plate.

Furthermore, in the case of a COB-type light source module, a light emitting surface (LES) is standardized according to the international standard ‘Zhaga.’ The integrally molded substrate 100 according to the present embodiment may include the holder portion 120 that complies with the Zhaga standard and provides a convenient attachment structure. Therefore, the integrally molded substrate 100 according to the present embodiment may embody a light source module that corresponds to standard light source modules, provides a large amount of light, and is suitable for high quality interior illumination and an illumination apparatus including the same.

FIGS. 3A and 3B are perspective view diagrams respectively showing the substrate portion 110 and the holder portion 120 of the integrally molded substrate 100 of FIG. 1, and FIG. 3C is a sectional view of the integrally molded substrate of FIG. 3A obtained along a line II-II′. The substrate portion 110 and the holder portion 120 are separately shown only for convenience of explanation. In reality, the substrate portion 110 and the holder portion 120 are strongly integrated with each other via insert molding and cannot be separated from each other.

Referring to FIGS. 3A through 3C, the mounting region Am may be defined on the substrate portion 110. At least one LED chip for embodying a light source module may be mounted at the mounting region Am. In FIG. 3A, portions where LED chips will be mounted are shown as broken line rectangles Lc in the mounting region Am. Although FIG. 3A shows a structure in which dozens to hundreds of LED chips are mounted in the mounting region Am in an array structure, ten or less LED chips may be mounted in the mounting region Am or only one LED chip may be mounted in the mounting region Am, if needed.

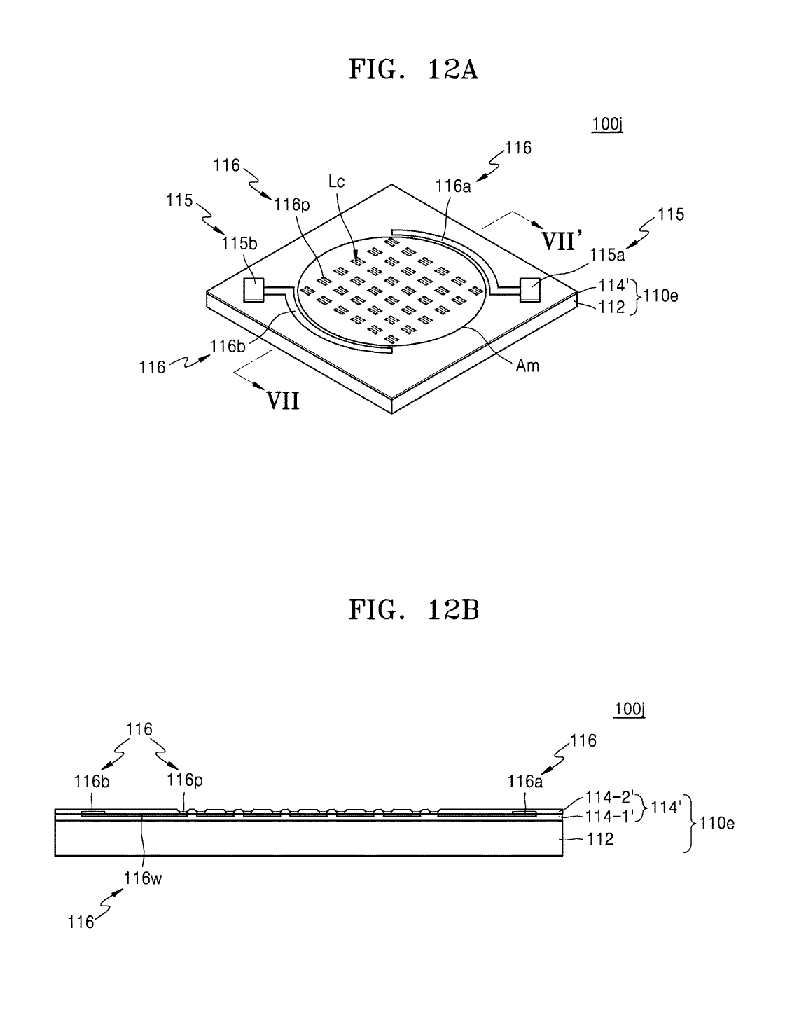

LED chips may be mounted at the mounting region Am via wire bonding or flip-chip bonding. If LED chips are mounted via wire bonding, no insulation layer may be formed on a portion of the metal layer 112. However, if LED chips are mounted via flip-chip bonding, an insulation layer may be formed on the metal layer 112. A structure of the substrate portion 110 in which an insulation layer is formed on a portion of the metal layer 112 at the mounting region Am will be described below with reference to FIGS. 12A and 12B. Furthermore, structures in which LED chips are mounted via wire bonding and flip-chip bonding will be described below in detail with reference to FIGS. 14C and 14D.

The wiring layer 116 may be formed outside the mounting region Am to surround the mounting region Am. The wiring layer 116 may include an anode electrode line 116a and a cathode electrode line 116b, wherein the anode electrode line 116a and the cathode electrode line 116b may be connected to LED chips in the mounting region Am in parallel. The term “parallel connection” may indicate that the anode electrode line 116a and the cathode electrode line 116b are respectively connected to the outermost LED chips, which are adjacent to the anode electrode line 116a or the cathode electrode line 116b. In the case of LED chips that are arranged along one direction between the anode electrode line 116a and the cathode electrode line 116b and includes two outermost LED chips and LED chips arranged between the two outermost LED chips, wirings may be connected thereto such that currents flow in series. However, connections of wirings with respect to the mounting region Am are not limited thereto.

The wiring layer 116 is connected to an electrode terminal 115, and the electrode terminal 115 may include an anode terminal 115a and a cathode terminal 115b corresponding to the anode electrode line 116a and the cathode electrode line 116b, respectively.

As described above, the holder portion 120 may include the open region Ao at the center. In the integrally molded substrate 100 formed by integrating the substrate portion 110 and the holder portion 120 with each other, the mounting region Am of the substrate portion 110 may be exposed via the open region Ao. As indicated by the broken lines, a wiring terminal 125 and a wiring line 126 may be arranged inside the holder portion 120.

The wiring terminal 125 may include an anode wiring terminal 125a and a cathode wiring terminal 125b. Furthermore, the wiring line 126 may include an anode wiring line 126a, which extends from the anode wiring terminal 125a and is connected to the connector 130, and a cathode wiring line 126b, which extends from the cathode wiring terminal 125b and is connected to the connector 130. In an integrally molded substrate (100 of FIG. 1), the anode wiring terminal 125a may be combined with the anode terminal 115a, whereas the cathode wiring terminal 125b may be combined with the cathode terminal 115b.

In detail, the integrally molded substrate 100 may be fabricated by performing insert molding after the anode wiring terminal 125a and the anode wiring line 126a are arranged in a mold in order to physically attach the anode wiring terminal 125a to the anode terminal 115a of the substrate portion 110 and the cathode wiring terminal 125b and the cathode wiring line 126b are arranged in a mold in order to physically attach the cathode wiring line 126b to the cathode terminal 115b. The connector 130 is also formed during the insert molding, and thus the anode wiring line 126a and the cathode wiring line 126b may be arranged to be connected to the connector 130.

The connector 130 may have various structures to be easily attached to and detached from an external wiring (140 of FIG. 1). For example, a terminal end of an external wiring may have a male plug structure and the connector 130 may have a female plug structure, or vice versa. Furthermore, structure of the connector 130 is not limited to male and/or female plug structures, and the connector 130 may have various connecting structures according to connecting structure of an external wiring, and thus the connector 130 may provide excellent compatibility to the integrally molded substrate 100. Therefore, when the integrally molded substrate 100 according to the present embodiment is embodied as a light source module (e.g., 500 of FIG. 14C) by mounting LED chips thereto and is used in an illumination apparatus (e.g., 1000 of FIG. 14A), the integrally molded substrate 100 may be easily replaced by attaching screws and connecting the external wiring to the connector 130. In other words, the integrally molded substrate 100 according to the present embodiment may be easily replaced in a set or an illumination apparatus based on the compatibility with the set or the illumination apparatus.

As shown in FIG. 3C, the insulation layer 114 includes the lower insulation layer 114-1 and the upper insulation layer 114-2, where a wiring layer, e.g., an electrode line 116, may be arranged between the lower insulation layer 114-1 and the upper insulation layer 114-2. As described above, a portion of the electrode line 116 may be covered by the upper insulation layer 114-2 and the other portion of the electrode line 116 may be exposed. The exposed portion of the electrode line 116 may be electrically connected to LED chips mounted at the mounting region Am via wires. Although not shown, the electrode terminal 115 may be partially or completely exposed from the upper insulation layer 114-2 and may be physically and electrically combined with the wiring terminal 125 of the holder portion 120 later during an insert molding.

FIGS. 4 through 6 are sectional views of integrally molded substrates corresponding to FIG. 2, according to exemplary embodiments. For convenience of explanation, descriptions already given above with reference to FIGS. 1 through 3C will be given briefly or omitted.

Referring to FIG. 4, an integrally molded substrate 100a according to the present embodiment may be identical to the integrally molded substrate 100 of FIG. 1 except for the bottom surface of a holder portion 120a. In detail, in the integrally molded substrate 100 of FIG. 1, the bottom surface Sbh of the holder portion 120, that is, the bottom surface Sbh of the expanding region He and the bottom surface Sbs of the substrate portion 110 form a same surface. However, the integrally molded substrate 100a according to the present embodiment may have a structure in which the bottom surface Sbs of the substrate portion 110 may protrude more than the bottom surface S′bh of the holder portion 120a. For example, the bottom surface Sbs of the substrate portion 110 may protrude more than the bottom surface S′bh of the holder portion 120a by a first thickness D1. The first thickness D1 may be in a range from dozens of μm to about hundreds of μm.

Since the bottom surface Sbs of the substrate portion 110 protrudes more than the bottom surface S′bh of the holder portion 120a, when the integrally molded substrate 100a is screw-attached to a heat radiating unit, such as a heat sink, the bottom surface Sbs of the substrate portion 110 may be more closely attached to the heat sink. The heat radiating efficiency of a heat sink may be improved as the bottom surface Sbs of the substrate portion 110 closely contacts the heat sink. For example, if the bottom surface Sbs of the substrate portion 110 does not contact a heat sink close enough, a gap may be formed therebetween, and the air or impurities with poor heat conductivity may be introduced into the gap. As a result, heat transmitted to the heat sink may be reduced. Reduction of heat transmitted to a heat sink may deteriorate heat radiating efficiency of the heat sink, thereby deteriorating reliability of a light source module or an illumination apparatus.

The integrally molded substrate 100a according to the present embodiment is formed, such that the bottom surface S′bh of the holder portion 120a protrudes more than the bottom surface Sbs of the substrate portion 110, thereby increasing closeness of contact between the integrally molded substrate 100a and a heat sink. As a result, heat radiating efficiency of the heat sink may be improved. Furthermore, a light source module or an illumination apparatus including the integrally molded substrate 100a according to the present embodiment may have improved reliability based on improved heat radiating efficiency of a heat sink.

Referring to FIG. 5, an integrally molded substrate 100b according to the present embodiment may be identical to the integrally molded substrate 100 of FIG. 1 except for a size of a substrate portion 110a. For example, in the integrally molded substrate 100 of FIG. 1, the first width W1 of the substrate portion 110 exceeds a half of the second width W2 of the holder portion 120. However, in the integrally molded substrate 100b according to the present embodiment, the substrate portion 110a may have a third width W3, where the third width W3 may be smaller than a half of the second width W2. Furthermore, if it is assumed that the mounting region Am has a same size as in the previous embodiments, as a width or an area of the substrate portion 110a decreases, a portion of the top surface Sts of the substrate portion 110a covered by the holder portion 120 may be very narrow.

Although a size of the substrate portion 110a is different from a size of the substrate portion 110 in the integrally molded substrate 100 of FIG. 1, the substrate portion 110a may include a metal layer 112a and an insulation layer 114a, similar to the substrate portion 110 of the integrally molded substrate 100a of FIG. 1. In the case of a metal-based PCB, materials and processing cost therefor may be relatively expensive. Therefore, size reduction of the substrate portion may result in reduction of fabricating cost of an integrally molded substrate or overall cost for manufacturing a light source module or an illumination apparatus. If the substrate portion 110a is formed to have a relatively small size, the substrate portion 110a may employ a heat slug. A heat slug is a conductive pad for transmitting heat and is also referred to as a thermal coupler. In the case of employing a heat slug, a substrate formed of an epoxy resin, such as FR4, may be used.

As described above, main functions of the holder portion 120 may be fixing the substrate portion 110a to a heat sink and including a connector for connecting an external wiring. Therefore, as long as screw holes for fixing to a heat sink and a connector may be arranged, a size of the holder portion 120 may also be reduced. For example, in the integrally molded substrate 100b according to the present embodiment, the second width W2 of the holder portion 120 may be reduced, such that a side surface of the substrate portion 110a is nearby the screw hole 122, similar to the structure of the integrally molded substrate 100 of FIG. 1. Size reduction of the holder portion 120 may contribute to cost reduction regarding an integrally molded substrate, a light source module, or an illumination apparatus.

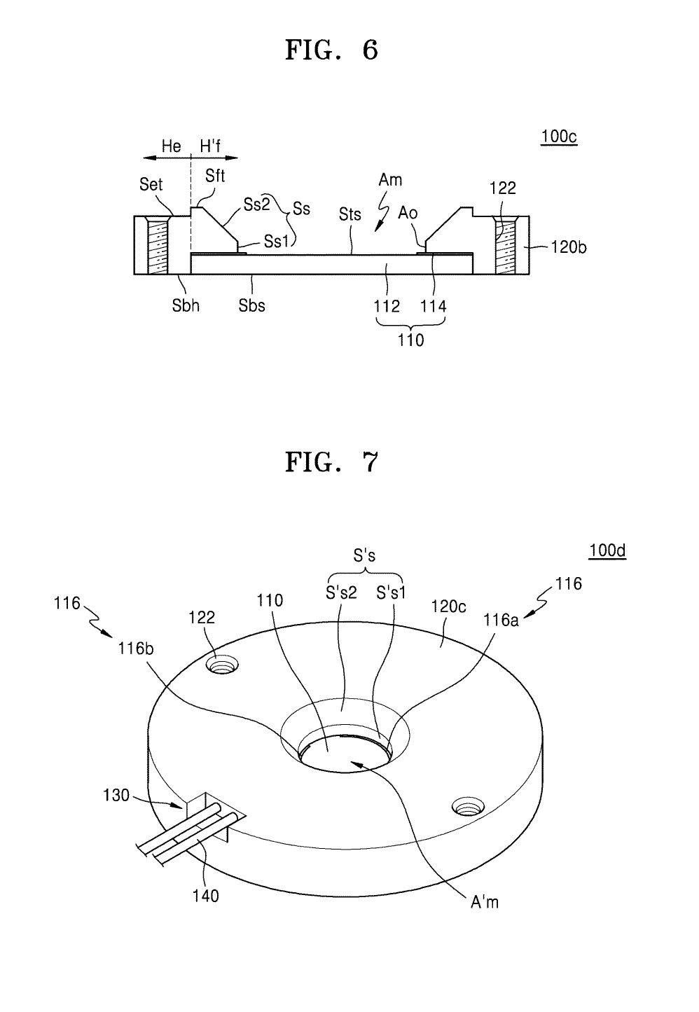

Referring to FIG. 6, an integrally molded substrate 100c according to the present embodiment may be identical to the integrally molded substrate 100 of FIG. 1 except for a structure of the a holder portion 120b. In detail, in the holder portion 120 of the integrally molded substrate 100 of FIG. 1, the top surfaces St of the fence region Hf and the expanding region He form a same surface. However, in the integrally molded substrate 100c according to the present embodiment, the top surface Sft of a fence region H′f and the top surface Set of the expanding region He may not form a same surface. For example, as shown in FIG. 6, the top surface Sft of the fence region H′f may protrude more than the top surface Set of the expanding region He. As the top surface Sft of the fence region H′f protrudes more than the top surface Set of the expanding region He, the second portion Ss2 of the side surface Ss may be expanded, and thus a function of the second portion Ss2 as a reflector may be improved.

In the integrally molded substrate 100c according to the present embodiment, a function of the second portion Ss2 of the fence region H′f as a reflector is improved by expanding a size of the second portion Ss2, and thus a separate reflector may be omitted when the integrally molded substrate 100c is used to embody a light source module or an illumination apparatus. Therefore, when the integrally molded substrate 100c is used to embody a light source module or an illumination apparatus, the overall process may be simplified and costs including operation cost and material cost may be reduced.

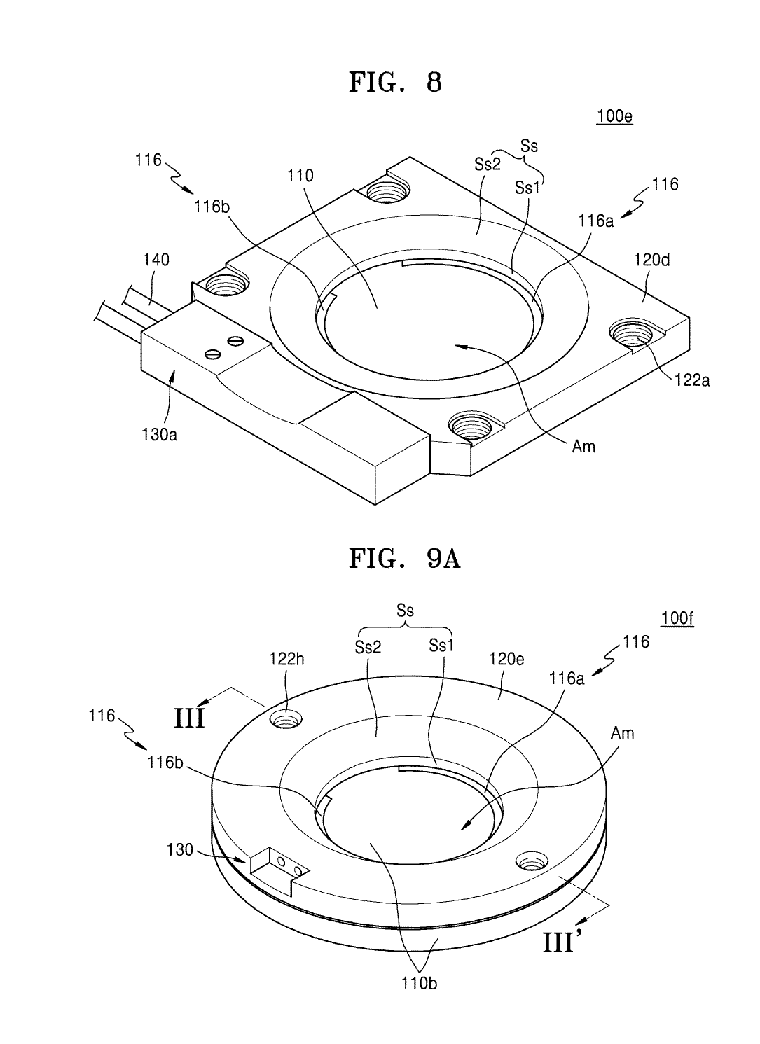

FIGS. 7 and 8 are perspective views of integrally molded substrates corresponding to FIG. 1, according to exemplary embodiments. For convenience of explanation, descriptions already given above with reference to FIGS. 1 through 3C will be given briefly or omitted.

Referring to FIG. 7, an integrally molded substrate 100d according to the present embodiment may be identical to the integrally molded substrate 100 of FIG. 1 except for a size of an open region of a holder portion 120c. For example, in the integrally molded substrate 100 of FIG. 1, an open region (Ao of FIG. 2 or 3B) is formed to be sufficiently large, where the diameter of the open region is about a half of the diameter of the holder portion 120. However, in the integrally molded substrate 100d according to the present embodiment, an open region may be very narrow, where the diameter of the open region is smaller than or equal to ⅓ of the diameter of the holder portion 120c.

Since the open region of the holder portion 120c has a small area, an exposed portion of a mounting region A′m of the substrate portion 110 may also be small. Therefore, although not shown, a size of the substrate portion 110 may also be reduced. Similar to the integrally molded substrate 100 of FIG. 1, the inner side surface S′s of the holder portion 120c may be nearby the mounting region A′m and may include a first portion S′s1 that is tilted with respect to the top surface of the substrate portion 110 by a relatively large angle and a second portion S′s2 that is tilted with respect to the top surface of the substrate portion 110 by a relatively small angle.

The integrally molded substrate 100d according to the present embodiment may be used when a relatively small number of LED chips are mounted to the mounting region A′m of the substrate portion 110. For example, the integrally molded substrate 100d according to the present embodiment may be used in the case of embodying a light source module or an illumination apparatus by using one to several LED chips.

Referring to FIG. 8, a shape of a holder portion 120d of an integrally molded substrate 100e according to the present embodiment may be completely different from that of the holder portion 120 of the integrally molded substrate 100 of FIG. 1. In detail, in the integrally molded substrate 100e according to the present embodiment, the holder portion 120d may have a rectangular structure similar to that of the substrate portion 110. Furthermore, four screw holes 122a may be formed at vertices of the rectangles, respectively. However, the number of the screw holes 122a is not limited thereto. For example, only two screw holes 122a may be formed in a diagonal direction.

As shown in FIG. 8, a connector 130a may be formed as an independent structure protruding from the holder portion 120d in a direction. The connector 130a having the structure may also be integrated with the substrate portion 110 and the holder portion 120d via insert molding. However, the connector 130a is not limited to an independent structure and may be formed as a portion of the holder portion 120d as in the integrally molded substrate 100 of FIG. 1.

Although the rectangular holder portion 120d is exemplified in the integrally molded substrate 100e according to the present embodiment, a structure of the holder portion 120d is not limited thereto. For example, in the case of forming a light source module or an illumination apparatus by using an integrally molded substrate, a holder portion may be formed to have any of various structures, such as a circular structure, an elliptical structure, and a polygonal structure, based on the structure of a housing for accommodating the integrally molded substrate.

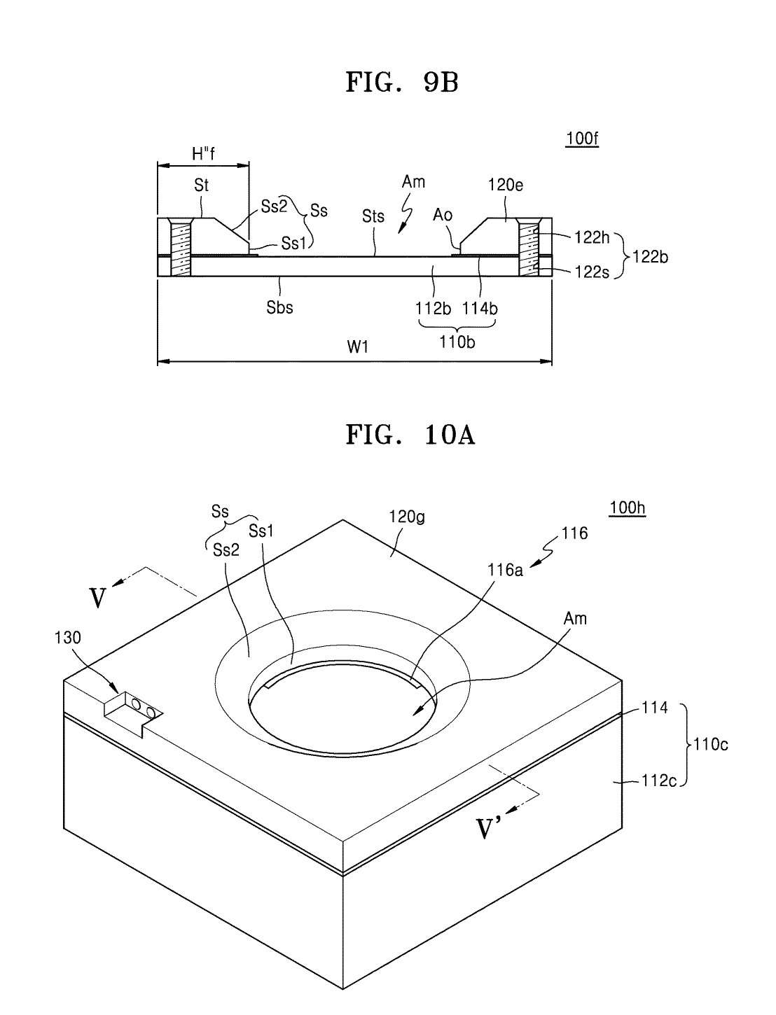

FIGS. 9A and 9B are a perspective view and a sectional view of an integrally molded substrate 100f according to an exemplary embodiment, where FIG. 9B is obtained along a line III-III′ of FIG. 9A. For convenience of explanation, descriptions already given above with reference to FIGS. 1 through 3C will be given briefly or omitted.

Referring to FIGS. 9A and 9B, an integrally molded substrate 100f according to the present embodiment may be different from the integrally molded substrate 100 of FIG. 1 in structures of a substrate portion 110b and a holder portion 120e. In detail, in the integrally molded substrate 100f according to the present embodiment, the substrate portion 110b may be formed to have a circular shape. Therefore, a metal layer 112b and an insulation layer 114b may also be formed to have circular shapes.

Furthermore, the holder portion 120e may only be formed on the top surface of the substrate portion 110b. For example, the holder portion 120e may not include an expanding region covering side surfaces of the substrate portion 110b and may only include a fence region H″f. Therefore, a side surface of the holder portion 120e may form a same surface with a side surface of the substrate portion 110b. According to an exemplary embodiment, the holder portion 120e may be formed to be smaller than the substrate portion 110b.

The top surface St of the fence region H″f may be larger than the top surface of the fence region Hf of the integrally molded substrate 100 of FIG. 1 to secure a space for screw holes 122h. Furthermore, screw holes 122s may also be formed in the substrate portion 110b. In other words, the integrally molded substrate 100f according to the present embodiment may be screw-attached to a heat radiating unit, such as a heat sink, via the screw holes 122b penetrating through the holder portion 120e and the substrate portion 110b.

In the integrally molded substrate 100f according to the present embodiment, both the substrate portion 110b and the holder portion 120e have circular structures, and the holder portion 120e is formed only on the top surface of the substrate portion 110b. However, a structure of the integrally molded substrate 100f according to the present embodiment is not limited thereto. For example, in the integrally molded substrate 100f according to the present embodiment, both a substrate portion and a holder portion may have structures with a same shape, e.g., an elliptical shape, a polygonal shape, etc., where the holder portion may be formed only on the top surface of the substrate portion.

Here, in the case of embodying a light source module or an illumination apparatus, the light source module or the illumination apparatus may include a separate reflector other than a holder portion. The reflector may be generally formed of a polymer material, such as poly phthal amide (PPA) or EMC. The reflector contains a material which has a high reflectivity, e.g., TiO2 or Al2O3, and may further contain a material with high heat resistant stability and high light resistant stability. A tilting angle of a side surface of the reflector may be adjusted based on a demanded beam angle, and the reflector may be formed to have a cascade structure or a hemispheric structure for angle adjustment.

The above-stated characteristics of the reflector including materials and structures thereof may be applied to the holder portions 120, 120a, 120b, 120c, 120d, and 120e of the integrally molded substrates 100, 100a, 100b, 100c, 100d, 100e, and 100f according to the exemplary embodiments. Furthermore, since a holder portion is formed via insert molding, a mixture of a polymer material and a light-reflecting material used for forming the holder portion may exhibit excellent fluidity during insert molding.

In the related art, when a light source module or an illumination apparatus is embodied by mounting LED chips on a PCB and attaching or assembling a reflector to the PCB or a substrate holder, a light source module or an illumination apparatus is structurally unstable and distortion or discoloration may occur. However, in the case of the integrally molded substrate 100, 100a, 100b, 100c, 100d, 100e, and 100f according to exemplary embodiments, a holder portion functioning as a reflector is integrated with a substrate portion via insert molding before LED chips are mounted and the LED chips are mounted thereafter, and thus the above-stated problems may be resolved.

When a light source module is embodied based on the above-stated integrally molded substrates 100, 100a to 100f according to exemplary embodiments, material cost and operation cost may be reduced as compared to a surface mounting device (SMD)-type light source module or a COB-type light source module in the related art as shown in Table 1 below.

TABLE 1

| | | Operation | | Operation | | Operation | | Operation |
|---|---|---|---|---|---|---|---|---|
| | Substrate | Cost | SMD | Cost | Holder | Cost | Reflector | Cost |
| SMD Type | ◯ | ◯ | ◯ | ◯ | ◯ | ◯ | ◯ | ◯ |
| COB Type | ◯ | ◯ | X | X | ◯ | ◯ | ◯ | ◯ |
| Integrally | ◯ | ◯ | X | X | X | X | Δ | Δ |
| molded | | | | | | | | |
| substrate | | | | | | | | |

Here, the items of substrate, SMD, holder, and reflector may indicate respective material costs, and the item of operation cost may indicate costs other than material costs in the respective operations. Referring to Table 1, in the case of a COB-type light source module in the related art or a light source module based on an integrally molded substrate according to exemplary embodiments, an SMD operation is omitted, and thus material cost and operation cost for the SMD operation may be omitted. Furthermore, according to exemplary embodiments, a holder operation is omitted as a holder and a substrate are integrally formed, material cost and operation cost for the holder operation may be omitted. Here, a holder may replace or include a connector. Therefore, material cost and operation cost for a connector may also be omitted. A reflector may be formed separately from a holder portion and may be integrated with the holder portion. In this case, material cost and operation cost for the reflector may be omitted. Since a reflector may be selectively arranged, the corresponding items in Table 1 are marked with A.

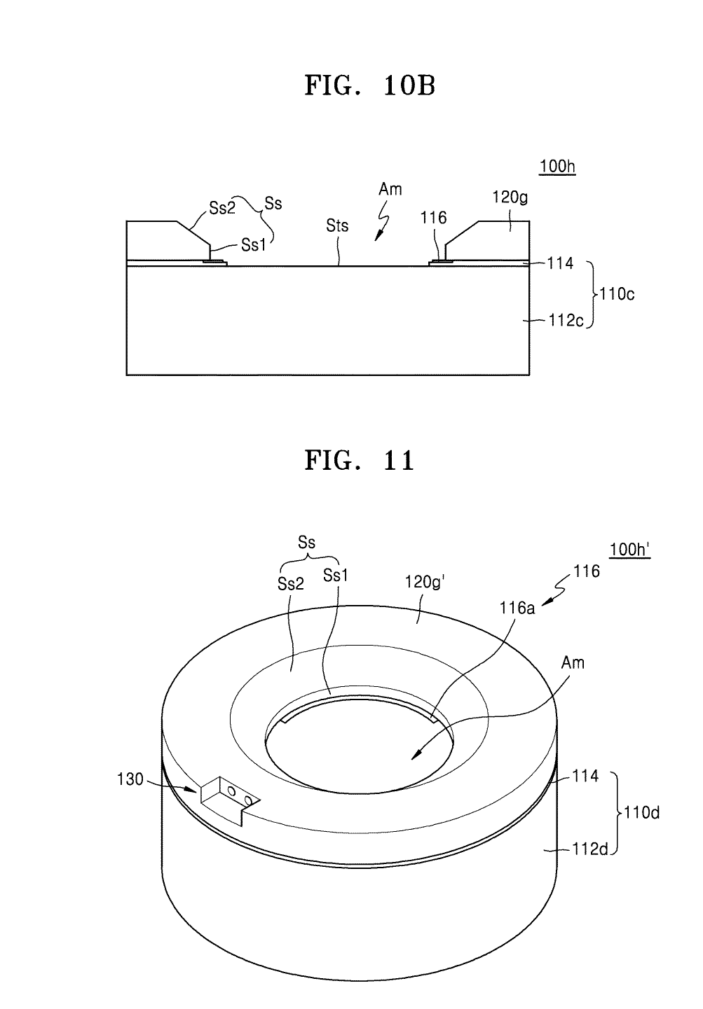

FIGS. 10A and 10B are a perspective view and a sectional view of an integrally molded substrate 100h according to an exemplary embodiment, where FIG. 10B is obtained along a line V-V′ of FIG. 10A. For convenience of explanation, descriptions already given above with reference to FIGS. 1 through 3C will be given briefly or omitted.

Referring to FIGS. 10A and 10B, the integrally molded substrate 100h according to the present embodiment may be identical to the integrally molded substrate 100 of FIG. 1 except for a metal layer 112c of a substrate portion 110c. For example, in the integrally molded substrate 100h according to the present embodiment, the metal layer 112c of the substrate portion 110c may be a heat sink. In other words, the substrate portion 110c may not be formed as a PCB unlike in the above-stated embodiments.

Similar to the substrate portions 110, 110a, and 110b according to the above described embodiments, the insulation layer 114 may be formed on the metal layer 112c, which is a heat sink, at the substrate portion 110c according to the present embodiment. A material and a function of the insulation layer 114 are identical to those described above with reference to FIG. 1. The mounting region Am is defined on the substrate portion 110c, where the insulation layer 114 may not be formed on a portion of the top surface of the metal layer 112c corresponding to the mounting region Am. The electrode line 116 may be formed outside the mounting region Am to surround the mounting region Am. The electrode line 116 may include the anode electrode line 116a and the cathode electrode line 116b. The anode electrode line 116a and the cathode electrode line 116b may be later connected to LED chips in the mounting region Am. Furthermore, the anode electrode line 116a and the cathode electrode line 116b may be connected to the connector 130 via wirings (125 and 126 of FIG. 3B) of a holder portion 120g.

In the integrally molded substrate 100h according to the present embodiment, the holder portion 120g may be formed only on the top surface of the substrate portion 110c as in the integrally molded substrate 100f of FIG. 9A. However, a structure of the holder portion 120g may be different from that of the holder portion 120e of the integrally molded substrate 100f.

In detail, although the holder portion 120e of the integrally molded substrate 100f of FIG. 9A has a structure having a circular horizontal section similar to the shape of the substrate portion 110b, the holder portion 120g of the integrally molded substrate 100h according to the present embodiment may have a structure having a rectangular horizontal section since the substrate portion 110c has a hexahedral shape. Therefore, outer side surfaces of the holder portion 120g may form same surfaces of side surfaces of the substrate portion 110c. A forming method, a material, and a structure regarding the holder portion 120g according to the present embodiment are identical to those according to the above-stated embodiments. Furthermore, side surfaces Ss of the holder portion 120g according to the present embodiment are nearby the mounting region Am and may include the first portion Ss1, which is arranged nearby the mounting region Am and is tilted with respect to the top surface of the substrate portion 110c by a relatively large angle, and the second portion Ss2, which is tilted with respect to the top surface of the substrate portion 110c by a relatively small angle.

Furthermore, in the integrally molded substrate 100h according to the present embodiment, the connector 130 may be formed as a portion of the holder portion 120g. Therefore, although not shown, wirings 125 and 126 may be arranged in the holder portion 120g similar to the holder portion 120 of FIG. 3B, where the wirings 125 and 126 may be electrically connected to the electrode line 116 on the mounting region Am of the substrate portion 110c. The holder portion 120g including the connector 130 may be integrated with the substrate portion 110c via insert molding.

Unlike in the integrally molded substrate 100f of FIG. 9A, no screw hole may be formed at the holder portion 120g in the integrally molded substrate 100h according to the present embodiment. This is because, since the substrate portion 110c functions as a heat sink, it is not needed to attach the substrate portion 110c to a heat radiating unit. Attachment units (or couplers) may be formed at the substrate portion 110c or the holder portion 120g to be attached to a supporting unit (or support), such as a housing accommodating the integrally molded substrate 100h. Examples of the attachment units may include, for example, hooks, clamps, screws, and other coupling mechanisms.

FIG. 11 is a perspective view of an integrally molded substrate 100h′ according to an exemplary embodiment. For convenience of explanation, descriptions already given above with reference to FIGS. 1 through 3C and FIGS. 10A and 10B will be given briefly or omitted.

Referring to FIG. 11, the integrally molded substrate 100h′ according to the present embodiment may be identical to the integrally molded substrate 100h of FIGS. 10A and 10B except for a shape thereof. For example, in the integrally molded substrate 100h′ according to the present embodiment, a substrate portion 110d may have a cylindrical shape, whereas a holder portion 120g′ may have a structure with a circular horizontal section according to a shape of the substrate portion 110d. Otherwise, the integrally molded substrate 100h′ is identical to the integrally molded substrate 100h of FIGS. 10A and 10B.

FIGS. 12A and 12B are a perspective view and a sectional view of an integrally molded substrate 100j according to an exemplary embodiment, where FIG. 12B is obtained along a line VII-VII′ of FIG. 12A. Here, FIG. 12A corresponds to FIG. 3A, FIG. 12B corresponds to FIG. 3C, and a structure of a holder portion is identical to that of the holder portion of FIG. 3B. Therefore, drawings thereof are omitted. For convenience of explanation, descriptions already given above with reference to FIGS. 1 through 3C will be given briefly or omitted.

Referring to FIGS. 12A and 12B, the integrally molded substrate 100j according to the present embodiment may be identical to the integrally molded substrate 100 of FIGS. 1 through 3C except for a structure of the substrate portion 110e. For example, in the integrally molded substrate 100j according to the present embodiment, the substrate portion 110e may have a structure appropriate for flip-chip bonding LED chips.

In detail, the substrate portion 110e includes the metal layer 112 and a insulation layer 114′, where the insulation layer 114′ may be formed on the mounting region Am. Furthermore, the insulation layer 114′ may include a lower insulation layer 114-1′ and a upper insulation layer 114-2′.

Electrode pads 116p may be exposed at portions Lc of the mounting region Am on which LED chips are to be mounted. Although FIG. 12a shows that the two electrode pads 116p are arranged in correspondence to respective LED chips, three or more electrode pads 116p may be arranged in correspondence to respective LED chips.

The electrode pad 116p may be electrically connected to a nearby electrode pad 116p and/or the electrode lines 116a and 116b via an internal wiring 116w therebelow. For example, as the electrode pads 116p and the internal wiring 116w are connected along a line as shown in FIG. 12B, when LED chips are mounted on the electrode pads 116p via flip-chip bonding, the corresponding LED chips may be electrically connected to each other in series. Furthermore, after the LED chips are mounted, the LED chips which constitute one line may be electrically connected to the LED chips of another line in parallel.

Furthermore, the integrally molded substrate 100j according to the present embodiment may include not only a holder portion having the structure of the holder portion 120 of the integrally molded substrate 100 of FIGS. 1 through 3C, but also a holder portion having any of various structures according to other exemplary embodiments. Furthermore, structure of the substrate portion 110e is not limited to a rectangular structure and may have any of various structures including a circular structure, an elliptical structure, etc.

FIGS. 13A through 13D are perspective views of integrally molded substrates 100k, 100l, 100m, and 100n according to exemplary embodiments. For convenience of explanation, descriptions already given above with reference to FIGS. 1 through 3C will be given briefly or omitted.

Referring to FIG. 13A, the integrally molded substrate 100k according to the present embodiment may be identical to the integrally molded substrate 100 of FIG. 1 through 3C except for a structure of an attachment unit (or a coupler). For example, in the integrally molded substrate 100k according to the present embodiment, a hook or a hook holder 122c for hook attachment may be formed instead of screw holes.

For example, if a hook is formed at the holder portion 120, a hook holder may be formed at a heat radiating unit or a housing to which the integrally molded substrate 100k is attached. On the other hand, if a hook holder is formed at the holder portion 120, a hook may be formed at a heat radiating unit or a housing to which the integrally molded substrate 100k is attached. Two or more hooks or hook holders 122c may be formed at the holder portion 120. Furthermore, according to an exemplary embodiment, only one hook or hook holder may be formed throughout the holder portion 120. Here, the hook holder is not limited to a ring-like structure and may refer to any structure to which a hook may be attached.

Referring to FIG. 13B, in an integrally molded substrate 100l according to the present embodiment, a snap protrusion 122d for snap attachment may be formed at the holder portion 120. When the snap protrusion 122d is formed at the holder portion 120, a snap groove for snap attachment with the snap protrusion 122d may be formed at a heat radiating unit or a housing to which the integrally molded substrate 100l is to be attached. A snap groove may be formed at the holder portion 120 instead of a snap protrusion. In this case, a snap protrusion may be formed at the heat radiating unit or the housing.

Referring to FIG. 13C, in an integrally molded substrate 100m according to the present embodiment, a screw thread 122e for screw attachment may be formed at the holder portion 120. As shown in FIG. 13C, the screw thread 122e may be formed throughout the outer surface of the holder portion 120, and thus the holder portion 120 may function as a screw. A screw hole corresponding to the screw thread 122e may be formed at a heat radiating unit or a housing to which the integrally molded substrate 100m is to be attached. Alternatively, a screw hole may be formed throughout the holder portion 120, and a screw thread may be formed at the heat radiating unit or the housing in correspondence to the screw hole.

Referring to FIG. 13D, an integrally molded substrate 100n according to the present embodiment may be similar to the integrally molded substrate 100k of FIG. 13A for forming a hook holder 122f for hook attachment at the holder portion 120. However, the integrally molded substrate 100n according to the present embodiment may be different from the integrally molded substrate 100k of FIG. 13A in that the hook holder 122f is provided at the upper portion of the holder portion 120, not at the lower portion of the holder portion 120.

If an attachment structure for hook attachment is formed at the upper portion of the holder portion 120 as in the integrally molded substrate 100n according to the present embodiment, the attachment structure may generally be the hook holder 122f. However, the inventive concept is not limited thereto. The three or more hook holder 122f may be formed at the holder portion 120. However, according to an exemplary embodiment, the two hook holder 122f may be formed at the holder portion 120 or the only one hook holder 122f may be formed on the top surface of the holder portion 120.

The attachment structure of the holder portion 120 is not limited to the above-stated attachment structures. For example, any type of attachment structure capable of attaching an integrally molded substrate to a heat radiating unit or a housing may be formed at the holder portion 120. Furthermore, an attachment structure may not only be formed at the holder portion 120, but also formed at both the holder portion 120 and the substrate portion 110 or only at the substrate portion 110.

Integrally molded substrates having various structures are described above. However, the inventive concept is not limited thereto. In other words, the technical spirit of the inventive concept applies to all types of integrally molded substrates formed by integrating at least one of a holder portion and a connector with a substrate portion, on which LED chips are to be mounted, via insert molding.

FIGS. 14A and 14B are a sectional view and an exploded perspective view of an illumination apparatus 1000 according to an exemplary embodiment, and FIGS. 14C and 14D are sectional views of illumination modules employed by the illumination apparatus 1000 of FIG. 14A. For convenience of explanation, descriptions already given above with reference to FIGS. 1 through 3C will be given briefly or omitted.

Referring to FIGS. 14A through 14D, the illumination apparatus 1000 according to the present embodiment may include an integrally molded substrate 100, LED chips 101, a heat sink 200, an optical plate 300, and a reflector 600.

The integrally molded substrate 100 may be the integrally molded substrate 100 of FIG. 1. Therefore, the integrally molded substrate 100 may include the substrate portion 110 and the holder portion 120, where the substrate portion 110 and the holder portion 120 may be integrated with each other via insert molding. The plurality of LED chips 101 may be mounted at the mounting region Am of the substrate portion 110. The LED chips 101 may be mounted via wire-bonding or flip-chip bonding and may be electrically connected to wirings of the mounting region Am. Furthermore, the LED chips 101 may be mounted at the mounting region Am in an array shape as shown in FIG. 3A or FIG. 12A.

If the LED chips 101 are mounted via wire-bonding, inactive surfaces of the LED chips 101 may be adhered and fixed to the metal layer 112 of the substrate portion 110 via an adhesive or the like and active surfaces of the LED chips 101 may face upward, as shown in a light source module 500 of FIG. 14C. Chip pads are formed on the active surfaces, and the wires 105 may be connected to the chip pads. The LED chips 101 may be connected to one another via the wires 105 and may also be connected to electrode lines (116 of FIG. 3A). As described above, the LED chips 101 on a same line may be connected to one another in series via the wires 105.

If the LED chips 101 are mounted via flip-chip bonding, the LED chips 101 may be attached to electrode pads (116p of FIG. 12B) exposed on the top surface of the substrate portion 110 via bumps 107, as shown in a light source module 500a of FIG. 14D. In the flip-chip bonding, active surfaces of the LED chips 101 face toward the substrate portion 110, and chip pads on the active surfaces may be attached and electrically connected to the electrode pads of the substrate portion 110 via the bumps 107. The LED chips 101 are electrically connected to one another in series via internal wirings 116w and may also be connected to electrode lines (116 of FIG. 3A). The LED chips 101 on a same line may be connected to one another in series via the internal wirings 116w. Here, in the light source modules 500 and 500a shown in FIGS. 14C and 14D, a molding material 180 is not hatched to clearly distinguish the LED chips 101, the wires 105, and the bumps 107.

Based on demanded functions, the LED chips 101 may have various structures and light-emitting efficiencies. The LED chip 101 may have a structure in which a first semiconductor layer, an active layer, and a second semiconductor layer are stacked on a substrate in the order stated and electrodes are formed on the first semiconductor layer and the second semiconductor layer. The first semiconductor layer, the active layer, and the second semiconductor layer constitute a light-emitting stack structure, where a buffer layer may be interposed between the light-emitting stack structure and the substrate. The LED chip 101 may be embodied in any of various structures including a horizontal structure in which first and second electrodes are arranged on a same surface as a light extracting surface, a flip-chip structure in which first and second electrodes are arranged away from the light extracting surface, a vertical structure in which first and second electrodes are arranged on surfaces opposite each other, and a horizontal-vertical structure in which a plurality of vias are formed on each chip to improve current dispersing efficiency and heat radiating efficiency, etc. Since materials, functions, and structures regarding each layer of the LED chip 101 are already know in the art, detailed descriptions thereof will be omitted.

The LED chips 101 may receive power supply and emit light. As shown in FIG. 14B, the LED chips 101 may be arranged in an array shape. The LED chips 101 may consist of a same type of LED chips emitting light beams of a same wavelength. Alternatively, the LED chips 101 may consist of heterogeneous LED chips emitting light beams of different wavelengths.

If the LED chips 101 emit a blue light beam, white light beams of various color temperatures may be emitted by adding at least one of a yellow phosphor, a green phosphor, and a red phosphor in a suitable mixing proportion to the LED chips 101. Furthermore, by applying a green phosphor or a red phosphor to the blue LED chips 101, a green light beam or a red light beam may be emitted. A white light beam, a green light beam, or a red light beam may be emitted by applying different phosphors to the respective LED chips 101, where a color temperature and color rendering index (CRI) of a white light beam may be adjusted by suitably combining the white light beam, the green light beam, and the red light beam with one another.

Furthermore, by suitably applying phosphors, the LED chips 101 may be configured to emit a purple light beam, a blue light beam, a green light beam, a, or an infrared ray. In this case, the illumination apparatus 1000 may adjust the CRI to the level of sunlight from light of natrium lamp and may emit various white light beams having color temperatures ranging from 1500K to 20000K. Furthermore, if needed, the illumination apparatus 1000 may emit purples, blue, green, red, or orange visible ray or an infrared ray to adjust color of illumination based on a mood or feeling of a user. The illumination apparatus 1000 may also emit a light beam of a particular wavelength capable of promoting growth of a plant.

A white light beam formed by applying yellow, green, and red phosphors to the blue LED chips 101 and/or by combining a green light beam or a red light beam has two or more peak wavelengths, where, as shown in FIG. 15A, a coordinate (x, y) of the white light beam in the CIE coordinate system may be located on a line segment connecting coordinates (0.4476, 0.4074), (0.3484, 0.3516), (0.3101, 0.3162), (0.3128, 0.3292), (0.3333, 0.3333). Furthermore, the white light beam may be located in a domain surrounded by the line segment and a block-body radiation spectrum. Color temperature of the white light beam may be from about 1,500K to about 20,000K.

Here, a light beam emitted by the light source module 500 or 500a or the illumination apparatus 1000 may have a color coordinate of a location in the CIE coordinate system of FIG. 15A and a corresponding color temperature. Furthermore, by applying a suitable phosphor and a reflector, color coordinate or color temperature may be shifted. For example, in the graph shown in FIG. 15A, the lower-left portion may correspond to a color coordinate of a light beam emitted by a blue LED chip, and the color coordinate may be shifted to the upper-left portion by applying a green phosphor. Furthermore, by applying a red phosphor, the color coordinate may be shifted to the right. The portions of B through D in the Planckian Locus at the center of the CIE coordinate system correspond to white light beams, wherein the light source module 500 or 500a or the illumination apparatus 1000 may generally emit light beams in the range of color coordinates. However, in the case of a defective combination proportion of phosphors or an incorrect angle of a reflector, a color coordinate or a color temperature is shifted, and thus a light beam within a demanded range of color coordinates may not be obtained.

For example, even if emitted light beams are within a desired range of color coordinates immediately after the LED chips 101 are mounted on a substrate, changes of optical paths and/or changes of brightness may occur due to defects of the LED chips 101 or an incorrect angle of a reflector occurring when the substrate is combined with a holder and/or a reflector, and thus color coordinates may be shifted. The shift of the color coordinates may cause color coordinates to be shifted out of a desired range of color coordinates, thereby causing defects of the light source module 500 or 500a or the illumination apparatus 1000.

FIG. 15B is a diagram showing a case in which a defect occurs in an illumination apparatus due to shift of color coordinates. For example, regarding 395 products, a defective ratio may be increased by 10% or more when color coordinates are shifted by an average of (0.001, 0.0015). Here, the broken lines may indicate a range of color coordinates demanded by the products, ‘Ref.’ may indicate color coordinates of the products prior to shift of color coordinates, and ‘Shift’ may indicate color coordinates of the products after the shift of color coordinates. As shown in FIG. 15B, color coordinates of the products are mostly arranged in the desired range of color coordinates and may be determined as normal before shift of color coordinates. However, after shift of color coordinates, some of the products are out of the desired range of color coordinates and may be determined as defective products.

The LED chips 101 may include nanostructures to reduce heat generation (hereinafter, an LED chip including a nanostructure will be referred to as a “nano LED chip”). As an example of nano LED chips, a core/shell nano LED chip, which has been recently developed, may generate relatively low heat due to a small combination density, may improve a light emitting efficiency by having an increased light emitting area due to use of nanostructures, and may include a non-polar active layer for preventing deterioration of the light-emitting efficiency due to polarization and enhancing a droop characteristic. Furthermore, in a nano LED chip, nanostructures may have different diameters, ingredients, or doping concentration, and thus a single device may emit two or more light beams of different wavelengths. Therefore, a white light beam may be embodied by using a single device by controlling wavelengths of light beams without application of a phosphor. Furthermore, another LED chip or a wavelength-changing material like a phosphor may be attached to such a nano LED chip, thereby embodying light beams of various colors or white light beams of different color temperatures.

After the LED chips 101 are mounted at the mounting region Am, the molding material 180 including phosphors may be applied thereto. The molding material 180 may include not only phosphors, but also silicone, glass, phototransmissive polymer, etc. If the LED chips 101 already contain phosphors, the molding material 180 may be formed of a transparent resin not containing a phosphor. A phosphor is a wavelength-changing material, where a wavelength of a light beam emitted by an LED chip may be changed by using a phosphor formed of a suitable material. Such a phosphor is generally used to embody a white LED by transforming a blue light beam emitted by a blue LED to a white light beam. However, the inventive concept is not limited thereto. For example, a phosphor may be used for a general fluorescent lamp, a three band radiation lamp, a high color rendering type fluorescent lamp, a copier lamp, or a fluorescent lamp for plant cultivation or insect repulsion and may also be used for a liquid crystal display (LCD), a plasma display panel (PDP), a cathode ray tube (CRT), or a field emission display (FED).

Phosphors used in the LED chips 101 may have composition formulas and colors as shown below.

Oxide-based: yellow and green Y₃Al₅O₁₂:Ce, Tb₃Al₅O₁₂:Ce, Lu₃Al₅O₁₂:Ce

Silicate-based: yellow and green (Ba,Sr)2SiO₄:Eu, yellow and orange (Ba,Sr)3SiO₅:Ce

Nitride-based: green β-SiAlON:Eu, yellow La₃Si₆N₁₁:Ce, orange α-SiAlON:Eu, red CaAlSiN₃:Eu, Sr₂Si₅N₈:Eu, SrSiAl₄N₇:Eu, SrLiAl₃N₄:Eu, Ln₄₋ₓ(Eu_{z}M_{1-z})ₓSi_{12-y}Al_{y}O_{3+x+y}N_{18-x-y} (0.5≦x≦3, 0<z<0.3, 0<y≦4)—Formula (1)

However, in Formula (1), Ln may be at least one atom selected from a group consisting of Group-IIIa atoms and rare-earth atoms, whereas M may be at least one atom selected from a group consisting of Ca, Ba, Sr, and Mg.

Fluoride-based: KSF-type red K₂SiF₆:Mn⁴⁺, K₂TiF₆:Mn⁴⁺, NaYF₄:Mn⁴⁺, NaGdF₄:Mn⁴⁺

The composition of a phosphor needs to comply with stoichiometry, so that each atom may be substituted with another atom in a corresponding Group of the Periodic Table. For example, Sr may be substituted with Ba, Ca, or MG of the alkali metal Group II, whereas Y may be substituted with lanthan-based atoms including Tb, Lu, Sc, and Gd. Furthermore, an activator, e.g., Eu, may be substituted with Ce, Tb, Pr, Er, or Yb based on a desired energy level, and the activator may be applied alone or a sub activator may be additionally applied for changing characteristics.

Furthermore, as replacements for phosphors, materials including a quantum dot (QD) may be applied, where a phosphor and a QD may be mixed with each other or independently applied to LED chips. QD may include a core (e.g., having a diameter from about 3 nm to about 10 nm), e.g., CdSe, InP, etc., a shell (e.g., having a thickness from about 0.5 nm to about 2 nm), e.g., ZnS, ZnSe, etc., and a ligand for core-shell stabilization and may embody various colors based on a size thereof.

An application of the molding material 180 containing phosphors may be performed in various ways. For example, examples of methods of applying the molding material 180 include an air-pressure method or a mechanical method, a dispensing method such as a jetting method for small amount control, a batch method such as a screen printing method or a spraying method, an electrophoretic or conformal coating method for locally coating a top surface and side surfaces of a chip, and a method of forming a ceramic phosphor or a film-type phosphor and attaching the same to a chip or a package.

As shown in FIGS. 14C and 14D, the molding material 180 may be applied to fill the first portion Ss1 of the side surfaces Ss of the holder portion 120. However, an application thickness of the molding material 180 is not limited thereto. For example, the molding material 180 may be applied to a height exceeding that of the first portion Ss1 or may be applied to a height lower than that of the first portion Ss1. The molding material 180 may be omitted depending on a light source module.

The reflector 600 is arranged on the integrally molded substrate 100 and, as described above, may be formed of a material with high reflectivity or a high reflection process may be performed on side surfaces of the reflector 600. The reflector 600 may increase brightness of light beams emitted by LED chips and may adjust beam angles of light beams based on tilting angles of the side surfaces. To adjust tilting angles of the side surfaces, the reflector 600 may have any of various structures including a cascade structure having two or more layers, a hemispheric structure, etc.

The reflector 600 may be attached to the integrally molded substrate 100 via various attachment methods including screw attachment and hook attachment. Therefore, attachment units for the corresponding attachment may be arranged at the reflector 600 and the integrally molded substrate 100. The reflector 600 may be attached to the heat sink 200 together with the integrally molded substrate 100. For example, screw holes may be formed at both wing portions of the reflector 600 and screws 170 may be inserted via the screw holes at the wing portions, and thus the reflector 600, the integrally molded substrate 100, and the heat sink 200 may be attached to one another at once.

In FIG. 14A, side surfaces of the reflector 600 and inner side surfaces of the holder portion 120 of the integrally molded substrate 100 have different angles, and thus the reflector 600 and the holder portion 120 may be attached to each other to form bent side surfaces. However, the structure of the illumination apparatus 1000 is not limited thereto. For example, side surfaces of the reflector 600 and inner side surfaces of the holder portion 120 may be attached to each other to form a same angle, and thus the side surfaces of the reflector 600 and the inner side surfaces of the holder portion 120 may form a same surface.

As described above, if a reflector function of the holder portion 120 is sufficiently efficient, the reflector 600 may be omitted.

The optical plate 300 may be arranged above the reflector 600 and may be fixed to the reflector 600 via an attachment ring 350. The optical plate 300 includes a diffuser plate, a phototransmissive plate, and a filter, where the optical plate 300 may be arranged at different locations based on functions thereof.

For example, the optical plate 300 simply functions as a phototransmissive plate that transmits light beams therethrough and protects LED chips inside the optical plate 300, the optical plate 300 may be arranged above the reflector 600. The optical plate 300 functioning as a phototransmissive plate may be formed of a transparent glass or a transparent plastic with high phototransmissivity. If a reflector is omitted, the optical plate 300 functioning as a phototransmissive plate may be arranged on the holder portion 120 of the integrally molded substrate 100.

The optical plate 300 may also function as a filter for transmitting light beams therethrough based on wavelengths. The optical plate 300 functioning as a filter may be arranged above the reflector 600 or on the holder portion 120 of the integrally molded substrate 100. The optical plate 300 may be formed of any of various materials based on demanded filter properties.

The optical plate 300 may function as a diffuser plate for protecting LED chips, diffusing light beams, and adjusting beam angles. The optical plate 300 functioning as a diffuser plate may be arranged on the holder portion 120 of the integrally molded substrate 100. The optical plate 300 functioning as a diffuser plate may be referred to as a lens according to structures thereof. Furthermore, the optical plate 300 functioning as a diffuser plate may be formed to completely cover the upper portion of the molding material 180, where the optical plate 300 having the corresponding structure may be referred to as an encapsulant. The optical plate 300 functioning as a diffuser plate may contain transparent epoxy and transparent silicon, may affect transmittance and reliability of light beams of visible ray wavelengths, and may affect optical efficiency and light distribution characteristics based on shapes or structures of application.

The optical plate 300 may be divided into a diffuser plate, a phototransmissive plate, and a filter, where the diffuser plate, the phototransmissive plate, and the filter may be individually fabricated and arranged at designated locations. For example, the diffuser plate may be arranged on the holder portion 120, whereas at least one of the phototransmissive plate and the filter may be arranged on the reflector 600.

The heat sink 200 is arranged below the integrally molded substrate 100, where a plurality of fins for heat radiation may be arranged on the bottom surface of the heat sink 200. Screw grooves 220 may be formed at the heat sink 200 in correspondence to screw holes 122 of the integrally molded substrate 100. Therefore, the integrally molded substrate 100 may be screw-attached to the heat sink 200 via screws 170. The integrally molded substrate 100 may be attached to the heat sink 200 in various ways including not only screw attachment, but also hook attachment, snap attachment, etc. In such cases, corresponding attachment structures may be formed at the integrally molded substrate 100 and the heat sink 200.

Heat radiating efficiency may vary based on structures or materials of the heat sink 200. If heat radiating efficiency is deteriorated, temperature of a light source module rises, and thus reliability of the light source module may be deteriorated. Therefore, the heat sink 200 may be designed to have an optimal heat radiating structure by using a highly heat conductive material. Furthermore, the heat sink 200 may employ a forced air flow generating technique based on use of an external fan or an external syncjet structure, or a phase change heat radiating technique based on use of a heat pipe and a heat spread. A weight of the heat sink 200 may be reduced via metal and/or resin double injection molding, for example. Furthermore, a thermal interface material may be used to improve contact between the heat sink 200 and the integrally molded substrate 100.

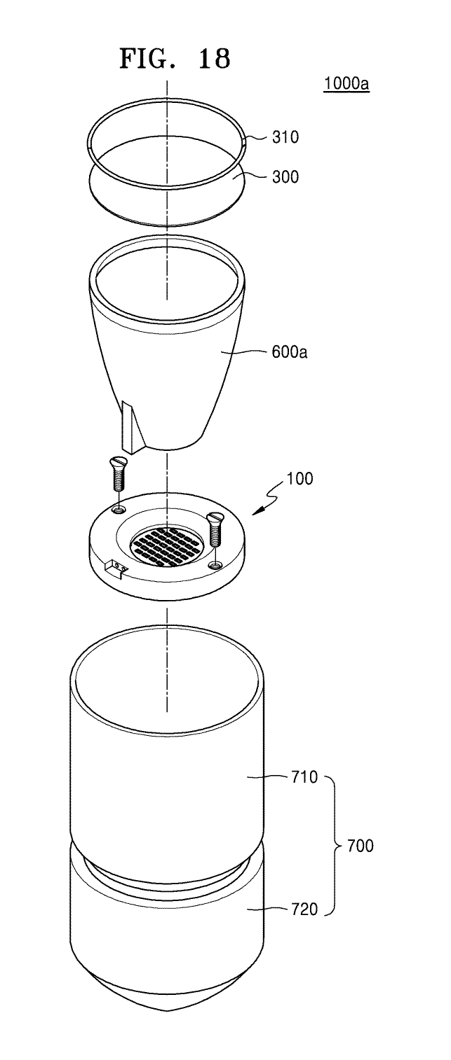

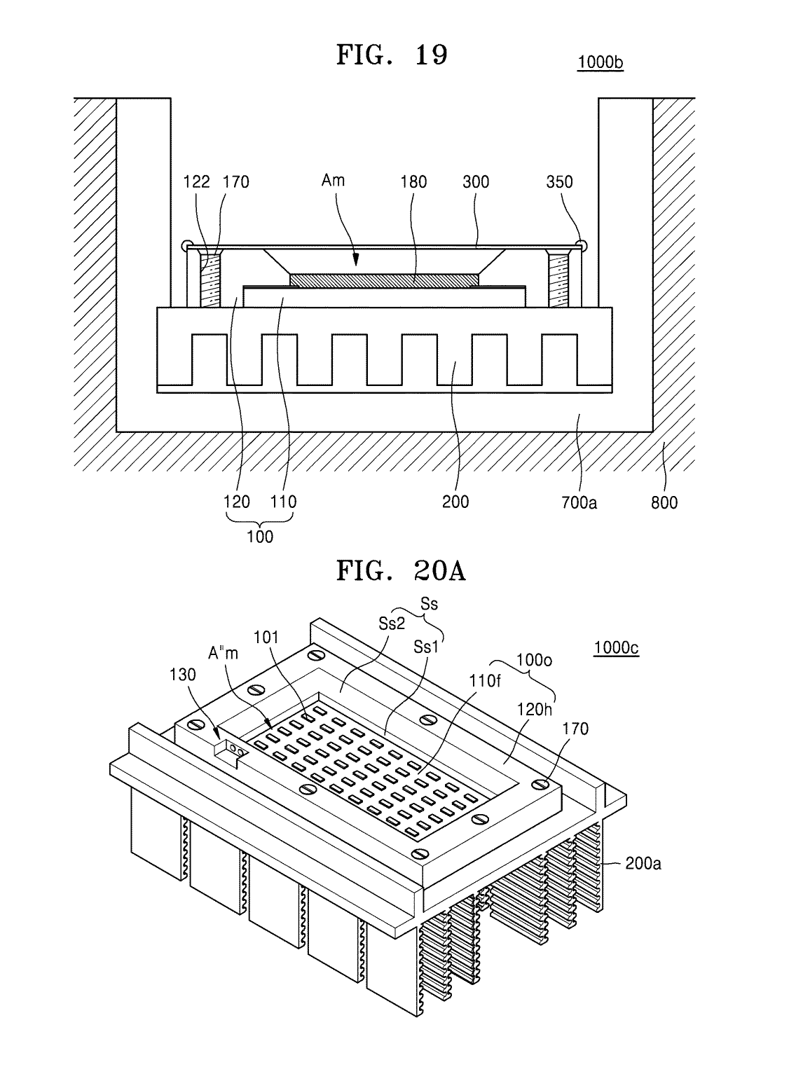

Although not shown, the illumination apparatus 1000 according to the present embodiment may further include a housing for accommodating the light source modules 500 and 500a, the reflector 600, and the heat sink 200. Furthermore, a power driving unit may be further arranged in the housing. Referring to FIGS. 18 and 19, illumination apparatuses 1000a and 1000b including a housing will be described below in detail. In the case of a light source module in the related art, a holder and a reflector are assembled after LED chips are mounted on a substrate. In the case of embodying a light source module or an illumination apparatus to satisfy some color coordinates or color temperature range, e.g., a 3-step region, the 3-step region may be satisfied after the LED chips are mounted on a substrate. However, when a substrate having LED chips mounted thereon is attached to a holder or a reflector, beam angles may be misaligned and defects may occur at LED chips, and thus the color coordinates may be shifted and the light source module or the illumination apparatus may be out of the 3-step region.

However, in the case of the light source modules 500 and 500a according to the present embodiment, the integrally molded substrate 100 formed by integrating the substrate portion 110 and the holder portion 120 with each other is prepared first, and LED chips may be mounted at the mounting region Am of the integrally molded substrate 100 to satisfy the 3-step region. Since a holder or a reflector is included to the integrally molded substrate 100, no attachment operation is needed after the LED chips are mounted. Therefore, possible defects during attachment operations in the related art may be completely prevented, and the light source modules 500 and 500a and the illumination apparatus 1000 may satisfy the 3-step region.

Here, the 3-step region may refer to the MacAdam 3-step. The MacAdam step is a reference for evaluating whether a measured color coordinate is viewed by the naked eyes as a reference color coordinate of the same color and may be categorized into 1 through 7 steps. The lower the MacAdam step is, the closer the measured color coordinate may be to the reference color coordinate. The 3-step region may indicate a relatively small color deviation that may hardly be recognized by ordinary people.

Although it is described above that the illumination apparatus 1000 includes the integrally molded substrate 100 of FIG. 1, the inventive concept is not limited thereto. For example, the integrally molded substrate 100 according to the present embodiment may include one from among the integrally molded substrates 100a through 100n of FIGS. 4 through 13D instead of the integrally molded substrate 100 of FIG. 1. Furthermore, if the illumination apparatus 1000 according to the present embodiment employs the integrally molded substrate 100h, 100h′, or 100i of FIGS. 10A through 11, the heat sink 200 may be omitted. Furthermore, the illumination apparatus 1000 may include one of integrally molded substrates having various structures in which at least one of a holder portion and a connector is integrated with a substrate portion via insert molding, instead of integrally molded substrates having the above-stated structures.

Each of the light source modules 500 and 500a and the illumination apparatus 1000 according to the present embodiment include the integrally molded substrate 100 in which the substrate portion 110 and the holder portion 120 are integrated with each other via insert molding, thereby embodying a light source module and an illumination apparatus having reasonable part structures and exhibiting high reliability due to highly precise and firm attachment with reduced costs and operation times.

Furthermore, since the light source modules 500 and 500a and the illumination apparatus 1000 according to the present embodiment are based on the integrally molded substrate 100, the light source modules 500 and 500a and the illumination apparatus 1000 according to the present embodiment may correspond to a standard light source module and exhibit no color coordinate shift. Therefore, a light source module and an illumination apparatus with excellent color quality may be embodied, and prices of the light source module and the illumination apparatus may be substantially lowered.

Furthermore, the light source modules 500 and 500a and the illumination apparatus 1000 according to the present embodiment may provide excellent compatibility and replacement convenience at a set or an illumination apparatus due to the structure of the holder portion 120 of the integrally molded substrate 100. Furthermore, the light source modules 500 and 500a and the illumination apparatus 1000 according to the present embodiment may be widely applied to general illumination apparatuses or interior illumination apparatuses, such as a down light bulb, a multifaceted reflector (MR)/parabolic aluminized reflector (PAR), a chandelier, a ceiling light, a bracket, and a spot light. Here, the down light is an illumination apparatus inserted into the ceiling to illuminate downward and may be used as a main indoor illumination apparatus. A ceiling light refers to an illumination apparatus directly attached to the ceiling without a chain or a pipe, whereas a bracket refers to an auxiliary illumination apparatus attached to a wall and is generally referred to as a wall light. A spotlight is an illumination apparatus that has a narrow beam angle and is used to shine light on a particular target.

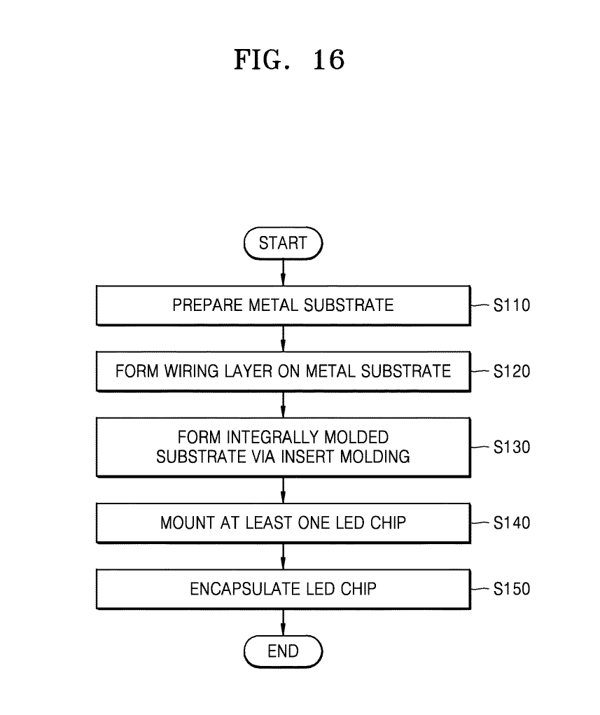

FIG. 16 is a flowchart of a method of manufacturing a light source module according to an exemplary embodiment.

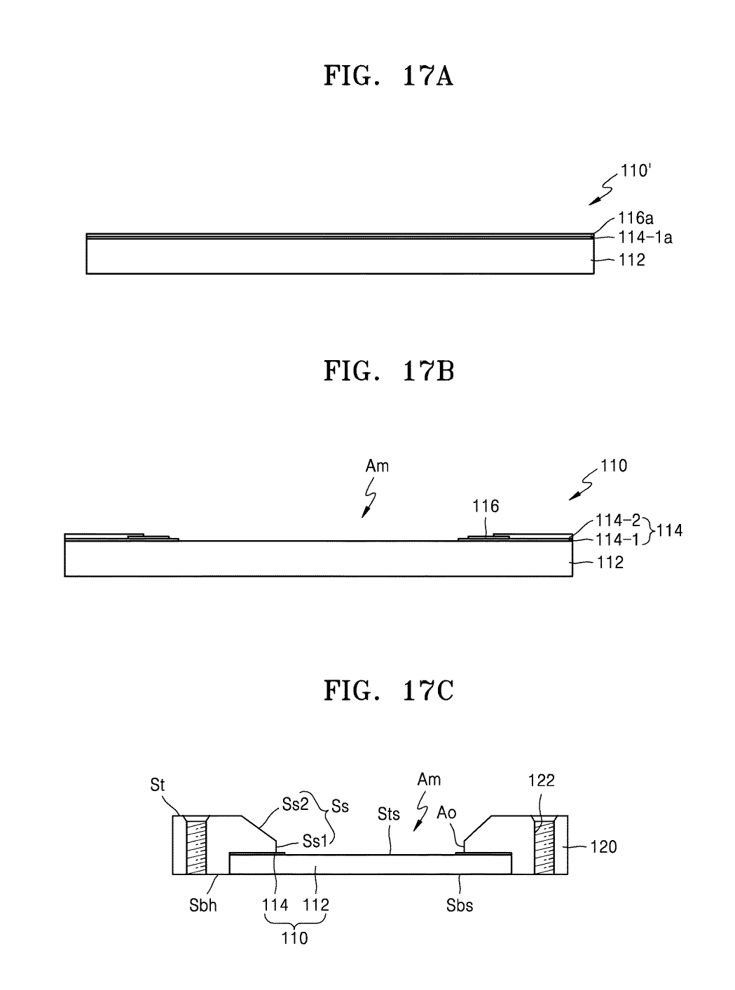

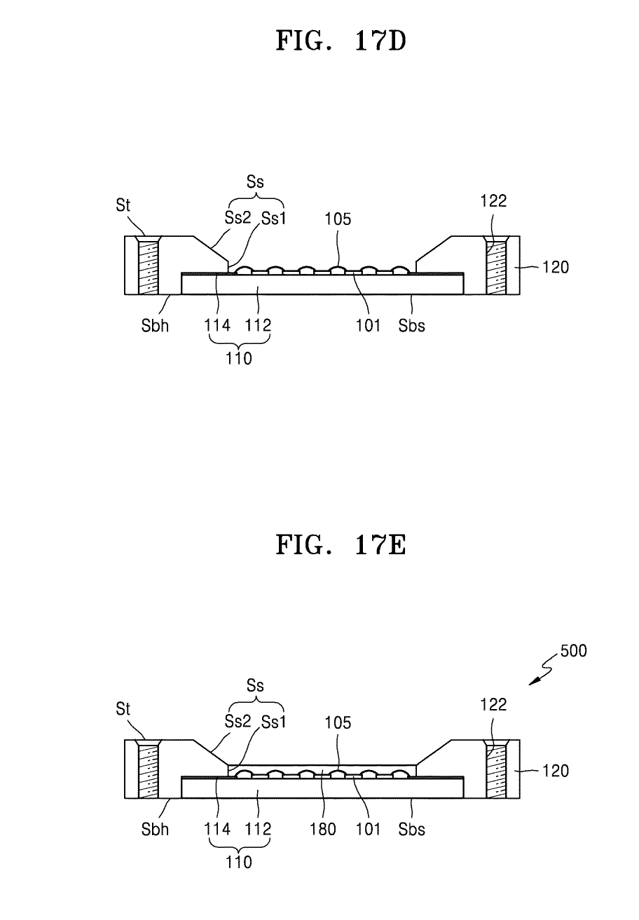

FIGS. 17A through 17F are sectional views showing operations for manufacturing a light source module corresponding to the flowchart shown in FIG. 16.

Referring to FIGS. 16 and 17A, a metal substrate 110′ is prepared (operation S110). The metal substrate 110′ may include the metal layer 112, a lower insulation layer 114-1a, and a metal thin-film 116a. The metal layer 112, the lower insulation layer 114-1a, and the metal thin-film 116a may correspond to the metal layer 112, the lower insulation layer (114-1 of FIG. 3C), and the wiring layer 116 of the substrate portion 110 of the integrally molded substrate 100 of FIG. 1, respectively. Therefore, descriptions of the metal layer 112, the lower insulation layer 114-1a, and the metal thin-film 116a are identical to the above-stated descriptions of the substrate portion 110 of the integrally molded substrate 100 of FIG. 1. According to the present embodiment, the metal layer 112 may be formed of Al, the lower insulation layer 114-la may be formed of FR4, and the metal thin-film 116a may be formed of Cu. However, the inventive concept is not limited thereto.

Referring to FIGS. 16 and 17B, the wiring layer 116 is formed on the metal substrate 110′ (operation S120). The wiring layer 116 may be formed by patterning the metal thin-film 116a of the metal substrate 110′ into a demanded shape. When the wiring layer 116 is formed, an electrode terminal (115 of FIG. 3A) may also be formed. The metal thin-film 116a may be patterned in one of two methods. For example, methods of patterning the metal thin-film 116a include a subtractive type patterning method and an additive type patterning method. The subtractive type patterning method is a method for removing a portion of a metal thin-film via etching and may be generally used for forming a large-sized pattern, whereas the additive type patterning method is a method for forming additional metal patterns on a metal thin-film via electroplating and may be generally used for forming a fine pattern. Here, the subtractive type patterning method may be inexpensive compared to the additive type patterning method. Therefore, the subtractive type patterning method may be used for a PCB for a module having formed therein relatively large patterns, whereas the additive type patterning method may be used for a component PCB having formed therein small patterns or an expensive PCB for a large scale integrated (LSI) circuit.

The wiring layer 116 may be formed on the metal substrate 110′ according to the present embodiment via the subtractive type patterning method. However, the inventive concept is not limited thereto, and the wiring layer 116 may also be formed on the metal substrate 110′ via the additive type patterning method.

As shown in FIG. 17B, the top surface of the metal layer 112 may be exposed at the mounting region Am. For example, the top surface of the metal layer 112 may be exposed as a portion of the lower insulation layer 114-la at the mounting region Am may be removed. Here, it is assumed that LED chips are mounted at the mounting region Am via wire bonding as shown in FIG. 17D. If LED chips are mounted at the mounting region Am via flip-chip bonding, the top surface of the metal layer 112 may not be exposed at the mounting region Am as shown in FIG. 12B. Furthermore, the wiring layer 116 may include electrode pads (116p of FIG. 12B). According to an exemplary embodiment, electrode pads may not be formed, and a portion of the internal wirings 116w may function as electrode pads.

The upper insulation layer 114-2 covering a portion of the wiring layer 116 may be formed on the lower insulation layer 114-1. The upper insulation layer 114-2 corresponds to the upper insulation layer of FIG. 3C and may be formed of PSR, for example. The lower insulation layer 114-1 and the upper insulation layer 114-2 may constitute the insulation layer 114 on the metal layer 112. The substrate portion 110 may be completed as the insulation layer 114 and the wiring layer 116 are formed on the metal layer 112.

Referring to FIGS. 16 and 17C, an integrally molded substrate is formed via insert molding (operation S130). The integrally molded substrate may include the substrate portion 110 and the holder portion 120. The integrally molded substrate is identical to the integrally molded substrate 100 of FIG. 1. Formations of inner wirings (125 and 126 of FIG. 3B) and a connector (130 of FIG. 3B) will be described below in detail. An anode wiring terminal (125a of FIG. 3B) and an anode wiring line (126a of FIG. 3B) are arranged in a mold in order to physically attach the anode wiring terminal (125a of FIG. 3B) onto an anode terminal (115a of FIG. 3A), and a cathode wiring terminal (125b of FIG. 3B) and a cathode wiring line (126b of FIG. 3B) are arranged in the mold in order to physically attach the cathode wiring terminal (125b of FIG. 3B) onto a cathode terminal (115b of FIG. 3A). Next, insert molding is performed, and thus the integrally molded substrate 100 may be fabricated. The connector (130 of FIG. 3B) is also formed during the insert molding. Therefore, parts for the connector (130 of FIG. 3B) are arranged at a designated region, and the anode wiring line (126a of FIG. 3B) and the cathode wiring line (126b of FIG. 3B) may be arranged to be attached to the parts for the connector.

The integrally molded substrate according to the present embodiment is not limited to the integrally molded substrate 100 of FIG. 1 and may have the structures of the integrally molded substrates of the above-stated embodiments. Here, in FIG. 17C, only the insulation layer 114 is shown, whereas the wiring layer 116 is omitted.

Referring to FIGS. 16 and 17D, the at least one LED chip 101 is mounted at the mounting region Am (operation S140). The LED chip 101 may be mounted via wire bonding. In detail, inactive surfaces of the LED chips 101 are adhered and fixed to the metal layer 112 of the substrate portion 110 via an adhesive first, and active surfaces of the LED chips 101 may face upward. Next, the wires 105 may be connected to chip pads formed on the active surfaces. The LED chips 101 are electrically connected to one another via the wires 105 and may also be connected to an electrode line (116 of FIG. 17B). Therefore, the LED chips 101 may be electrically connected to a wiring layer (116 of FIG. 17B) via the wires 105.

Of course, the LED chips 101 may also be mounted via flip-chip bonding. In this case, a substrate portion may have the structure of the substrate portion 110e as shown in FIG. 12B, and the LED chips 101 may be physically and electrically attached to the electrode pads 116p via bumps (107 of FIG. 14D). As a result, the LED chips 101 may be electrically connected to the wiring layer 116.

Referring to FIGS. 16 and 17E, the LED chips 101 are encapsulated by the molding material 180 (operation S150). The molding material 180 may contain phosphors. If the LED chips 101 are formed to contain phosphors at the wafer level, the molding material may not contain a phosphor and may be simply a transparent resin. The light source module 500 may be completed by encapsulating the LED chips 101 by using the molding material as described above. The light source module 500 may include an optical plate arranged on the holder portion 120.

Next, an overall illumination apparatus may be completed by performing operations including arranging an optical plate, attaching a heat sink, and accommodating the light source module 500 into a housing. Furthermore, a separate reflector may be selectively attached to the light source module 500.

FIG. 18 is an exploded perspective view of the illumination apparatus 1000a according to an exemplary embodiment.

Referring to FIG. 18, the illumination apparatus 1000a may include the integrally molded substrate 100, a reflector 600a, the optical plate 300, and a housing 700. The integrally molded substrate 100, the reflector 600a, and the optical plate 300 are identical to those described above with reference to FIGS. 14A through 14D. A heat sink is accommodated inside the housing 700 and is not shown in FIG. 18.

The housing 700 may include an upper housing 710 and a lower housing 720. The upper housing 710 may accommodate the integrally molded substrate 100, the reflector 600a, and the optical plate 300, whereas the lower housing 720 may accommodate the heat sink and a power driving unit. The lower housing 720 may accommodate a power supply unit, such as a primary battery or a secondary battery. Furthermore, a connector for connection to an external power supply unit may be arranged at the lower housing 720.

The illumination apparatus 1000a may embody a spot light illumination by narrowing beam angle of a light beam emitted by the reflector 600a.

FIG. 19 is a sectional view of an illumination apparatus 1000b according to an exemplary embodiment.

As shown in FIG. 19, the illumination apparatus 1000b according to the present embodiment may include the integrally molded substrate 100, the optical plate 300, the heat sink 200, and a housing 700a. The integrally molded substrate 100, the optical plate 300, and the heat sink 200 are identical to those described above with reference to FIGS. 14A through 14D.

The housing 700a accommodates the integrally molded substrate 100, the optical plate 300, and the heat sink 200 and may be fixed inside a wall 800. In the illumination apparatus 1000b according to the present embodiment, side surfaces of the housing 700a may function as a reflector. Therefore, a reflector may be omitted. According to an exemplary embodiment, a reflector may be separately fabricated, attached to the integrally molded substrate 100, and accommodated in the housing 700a.

Although not shown, a connector for connection to an external power supply unit may be arranged at the housing 700a. For example, power may be supplied to the illumination apparatus 1000b as the connector of the housing 700a is electrically connected to wirings arranged inside the wall 800.

The illumination apparatus 1000b may be built in the ceiling to emit light downward.

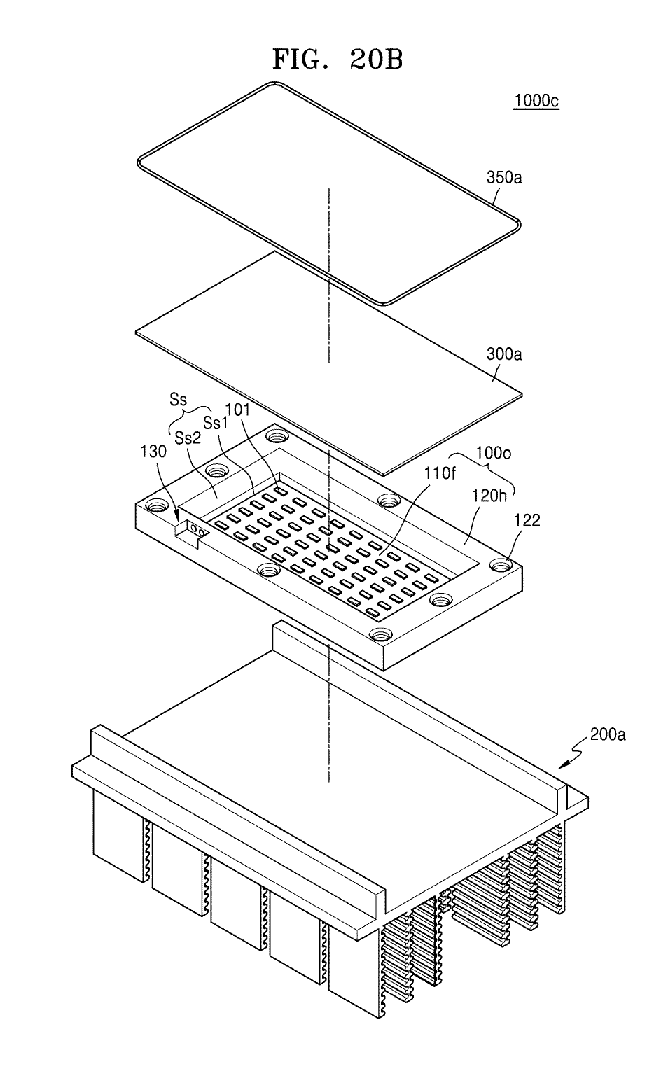

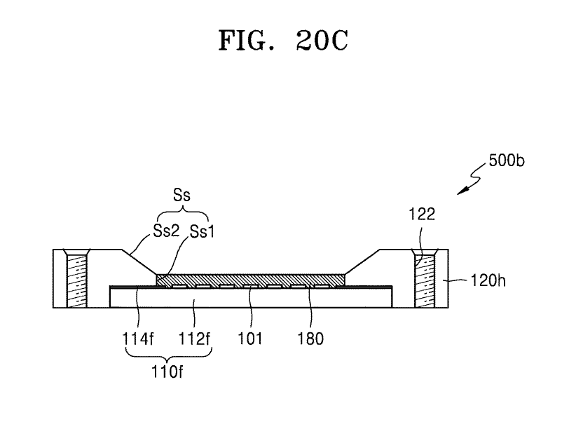

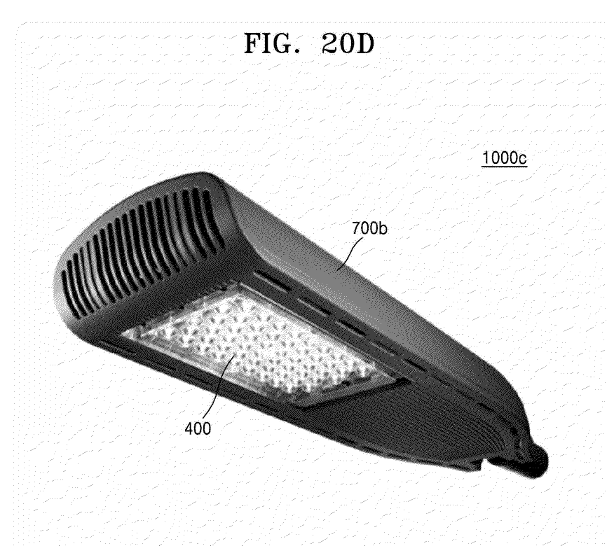

FIGS. 20A and 20B are a perspective view and an exploded perspective view of an illumination apparatus 1000c according to the present embodiment, FIG. 20C is a sectional view of a light source module employed by the illumination apparatus 1000c of FIG. 20A, and FIG. 20D is an example view of the illumination apparatus 1000c of FIG. 20A. For convenience of explanation, descriptions already given above with reference to FIGS. 1 through 3C and FIGS. 14A through 14D will be given briefly or omitted.

Referring to FIGS. 20A through 20D, although the overall structure of the illumination apparatus 1000c according to the present embodiment is different from that of the illumination apparatus 1000 of FIGS. 14A and 14B, basic components of the illumination apparatus 1000c according to the present embodiment may be similar to those of the illumination apparatus 1000. For example, the illumination apparatus 1000c according to the present embodiment may include a light source module 500b, a heat sink 200a, a phototransmissive cover 400, and a housing 700b.

The light source module 500b may include an integrally molded substrate 100o, the LED chips 101, the molding material 180 containing phosphors, and an optical plate 300a. The light source module 500b may have an overall rectangular structure. Therefore, the integrally molded substrate 100o and the optical plate 300a may have rectangular structures.

Although the integrally molded substrate 100o may have different shapes from the integrally molded substrates according to the above-stated embodiments, the integrally molded substrate 100o may also be formed via insert molding. For example, the integrally molded substrate 100o includes a substrate portion 110f and a holder portion 120h, where the substrate portion 110f and the holder portion 120h have rectangular structures and are integrated with each other via insert molding. Therefore, the integrally molded substrate 100o may have a structure in which the substrate portion 110f and the holder portion 120h may not be separated from each other. The integrally molded substrate 100o may be formed to have a large size, where a mounting region A″m may be larger than the mounting region Am of the integrally molded substrate 100 of FIGS. 14A and 14B. Since the mounting region A″m is large, a number of the LED chips 101 to be mounted at the mounting region A″m may increase.

The holder portion 120h may have a large size according to the size of the mounting region A″m, wherein the side surfaces Ss adjacent to the mounting region A″m may include the first portion Ss1, which is arranged nearby the mounting region Am and is tilted with respect to the top surface of the substrate portion 110f by a relatively large angle, and the second portion Ss2 which is tilted with respect to the top surface of the substrate portion 110f by a relatively small angle. The second portion Ss2 may function as a reflector. The connector 130 is formed at the holder portion 120h, and a plurality of screw holes may also be formed at the holder portion 120h. The integrally molded substrate 100o may be screw-attached and fixed to the heat sink 200a by using the plurality of screw holes formed at the holder portion 120h.

The molding material 180 containing phosphors may be applied onto the plurality of LED chips 101 arranged at the mounting region A″m of the substrate portion 110f. Furthermore, the optical plate 300a may be arranged on the top surface of the integrally molded substrate 100o, where the optical plate 300a may be fixed to the integrally molded substrate 100o via an attachment ring 350a. Since the optical plate 300a has a rectangular structure, the attachment ring 350a may also have a rectangular structure.

The top surface of the heat sink 200a may have a rectangular plate-like structure, such that the integrally molded substrate 100o may be attached thereto. Furthermore, guidelines, which protrude to accommodate the integrally molded substrate 100o as if the integrally molded substrate 100o is buried therebetween, may be formed at two opposite sides of the top surface of the heat sink 200a. A plurality of fins for heat radiation may be arranged on the bottom surface of the heat sink 200a. Each of the plurality of fins may have a wrinkled structure to maximize an area in contact with air.

The illumination apparatus 1000c according to the present embodiment may be used as an outdoor illumination apparatus. For example, as shown in FIG. 20D, the housing 700b may accommodate the light source module 500b and the heat sink 200a, and the phototransmissive cover 400 is arranged in front of the light source module 500b and attached to the housing 700b. As a result, the illumination apparatus 1000c may be embodied as an outdoor illumination apparatus.

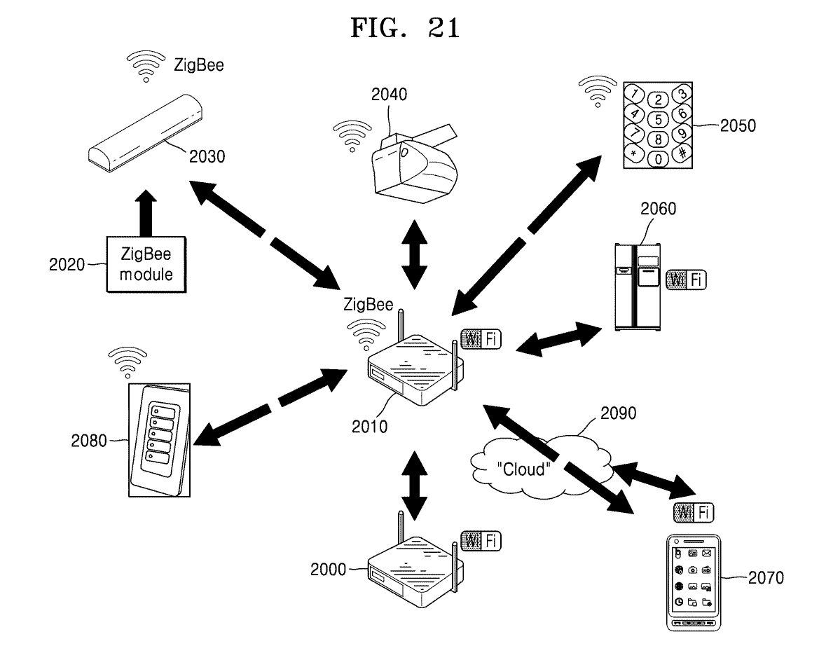

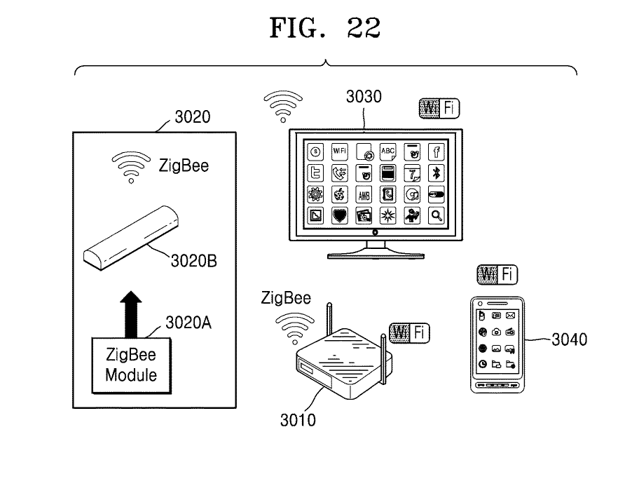

FIGS. 21 and 22 are diagrams showing examples of a home network to which an illumination apparatus according to an exemplary embodiment is applied.

Referring to FIGS. 21 and 22, the home network may include a home wireless router 2000, a gateway hub 2010 (or a gateway hub 3010), a Zigbee module 2020, an LED lamp 2030, a garage door lock 2040, a wireless door lock 2050, a home application 2060, a cellular phone 2070 (or a cellular phone 3040), a wall switch 2080, and a cloud network 2090.

The home network may perform a function for automatically turning the LED lamp 2030 on/off and automatically adjusting color temperature, CRI, and/or brightness of the LED lamp 2030 according to operating states of a bedroom, a living room, a doorway, and electronic devices and surrounding environments or circumstances by utilizing home wireless network, e.g., Zigbee, Wi-Fi, etc.

For example, as shown in FIG. 22, based on the type of a television (TV) program shown by a TV 3030 or a screen brightness of the TV 3030, brightness, color temperature, and/or CRI of an illumination apparatus 3020B (or an illumination system 3020) may be automatically adjusted via a Zigbee module 3020A. If a TV program shown on the TV 3030 is a drama, a color temperature may be lowered to a value below or equal to 12,000K, e.g., 5,000K, and feeling of colors is adjusted according to pre-set illuminance values, thereby creating a cozy atmosphere. On the other hand, if a TV program shown on the TV 3030 is a comedy program, a home network may be configured to increase a color temperature to a value equal to or higher than 5,000K and adjust an illumination apparatus for bluish white illumination, according to pre-set illuminance values. Furthermore, a smart phone or a personal computer (PC) may be used not only to turn an illumination apparatus on/off and to control brightness, color temperature, and/or CRI of the illumination apparatus, but also to control electronics connected thereto, e.g., the TV 3030, a refrigerator, an air conditioner, etc. via a home wireless communication protocol, such as Zigbee, WiFi, and light fidelity (LiFi). Here, the LiFi refers to a short-distance wireless communication protocol using visible rays.

For example, an illumination apparatus or an electronic device at home may be controlled by using a smart phone by embodying an illumination control application for a smart phone that displays color coordinate system as shown in FIG. 15A, mapping a sensor connected to all illumination apparatuses installed at home in conjunction with the color coordinate system by using Zigbee, Wi-Fi, or Li-Fi communication protocol (that is, displaying locations, current set values, and on/off state values of illumination apparatuses at home), selecting an illumination apparatus at a particular location and changing a state value regarding the illumination apparatus, where a state of the illumination apparatus is changed based on the changed set value.

The Zigbee module 2020 and the Zigbee module 3020A may be integrated with optical sensors or a light emitting device.

A visible ray wireless communication technique is a wireless communication technique for transmitting data by using light beams of the visible ray wavelength band that may be recognized by human eyes. The visible ray wireless communication technique is distinguished from wired optical communication techniques and is further distinguished from infrared ray wireless communication techniques in the related art due to use of light beams in the visible ray wavelength band. Furthermore, unlike radio frequency (RF) wireless communication, the visible ray wireless communication technique may be freely used without restrictions and permissions for using frequencies and exhibits excellent physical security, where a user may visually recognize a communication link. Furthermore, the original purpose as a light source and a communication function may be simultaneously fulfilled by using the visible ray wireless communication technique.

Furthermore, an LED illumination apparatus may be used as a light source inside and outside a vehicle. An LED illumination may be used as a light source for an interior light, a reading light, or a dashboard inside a vehicle and may be used as a light source for a headlight, a break light, a winker, a fog light, a daytime running light, etc., outside a vehicle.

An LED utilizing a particular wavelength band may promote growth of a plant, soothes emotion of a person, or cure a disease. An LED may be to a light source for a robot or any of various machine equipments. Based on low power consumption and long lifespan of the LED, an illumination apparatus may also be embodied based on an environment-friendly new renewable energy power system, such as a solar battery and a wind power generator.

Although a few embodiments have been shown and described, it would be appreciated by those skilled in the art that changes may be made in the exemplary embodiments without departing from the principles and spirit of the disclosure, the scope of which is defined in the claims and their equivalents.

1. A light source module for use in an illumination apparatus, the light source module comprising:
an integrally molded substrate comprising:
a substrate portion comprising a mounting region; and
a holder portion integrally provided with the substrate portion, wherein the holder portion covers at least a portion of a top surface of the substrate portion to expose the mounting region and comprises a reflective surface that is positioned adjacent to the mounting region; and
at least one light emitting diode (LED) chip mounted on the mounting region of the substrate portion.

2. The light source module of claim 1, wherein the at least one LED chip is covered with a molding material that comprises phosphors, and
the light source module has a chip-on-board (COB) structure.

3. The light source module of claim 1, wherein the holder portion comprises a coupler to be coupled to at least one of a heat sink and a housing of the illumination apparatus.

4. The light source module of claim 1, wherein the substrate portion is inserted into a lower portion of the holder portion, and
a bottom surface of the substrate portion and a bottom surface of the holder portion are at a same level or the bottom surface of the substrate portion protrudes from the bottom surface of the holder portion.

5. (canceled)

6. The light source module of claim 1, wherein the substrate portion comprises a heat sink.

7. The light source module of claim 1, wherein a connector electrically connected to the at least one LED chip is provided in the holder portion.

8. The light source module of claim 1, wherein the substrate portion comprises a metal layer, an insulation layer, and a wiring layer, and,
the metal layer has a higher reflectivity and is exposed in the mounting region.

9. The light source module of claim 8, wherein a portion of the wiring layer is exposed in the mounting region.

10. The light source module of claim 1, wherein an optical plate is arranged over the top surface of the holder portion.

11. (canceled)

12. An illumination apparatus, comprising:
an integrally molded substrate comprising:
a substrate portion comprising a mounting region; and
a holder portion integrally provided with the substrate portion, wherein the holder portion covers at least a portion of a top surface of the substrate portion to expose the mounting region and comprises a reflective surface at a side portion, the side portion being positioned adjacent to the mounting region;
at least one light emitting diode (LED) chip mounted on the mounting region;
an optical component arranged above the mounting region; and
a heat radiator coupled to a bottom portion of the integrally molded substrate.

13. The illumination apparatus of claim 12, wherein the at least one LED chip is covered by a molding material that comprises phosphors, and
the optical component comprises an optical plate, wherein the optical plate is arranged above the molding material and passes a light beam from the at least one LED chip therethrough.

14. The illumination apparatus of claim 13, wherein the optical plate comprises at least one of a diffuser plate configured to uniformly diffuse the light beam from the at least one LED chip, a phototransmissive plate configured to pass the light beam therethrough and protect the at least one LED chip, and a filter configured to pass the light beam according to a wavelength thereof.

15. The illumination apparatus of claim 12, wherein the substrate portion is inserted into a lower portion of the holder portion, and
the bottom surface of the substrate portion and the bottom surface of the holder portion are at a same level or the bottom surface of the substrate portion protrudes from the bottom surface of the holder portion.

16. The illumination apparatus of claim 12, wherein a first coupler is provided in the holder portion, and
a second coupler to be coupled to the first coupler is provided in the heat radiator.

17. The illumination apparatus of claim 12, wherein a power line that surrounds the mounting region and is electrically connected to the at least one LED chip is provided in the substrate portion, and
a connector that is electrically connected to the power line is provided in the holder portion.

18. The illumination apparatus of claim 12, wherein the substrate portion comprises a metal layer, an insulation layer, and a wiring layer, and
the metal layer has a higher reflectivity and the metal layer and a portion of the wiring layer are exposed in the mounting region.

19-30. (canceled)

31. A light source module comprising:
an integrally molded substrate comprising a first region on which at least one light emitting diode (LED) chip is mounted and a second region that surrounds the first region, wherein the first region and the second region comprise heterogeneous materials and the first region and the second region are integrally provided via insert molding.

32. The light source module of claim 31, wherein the first region is provided on a top surface of a metal substrate, and the second region covers side surfaces of the metal substrate and at least a portion of the top surface of the metal substrate.

33. The light source of module of claim 32, wherein a top surface of the second region comprises a portion that is tilted with respect to the top surface of the metal substrate, the portion of the second region having a reflectivity.

34. The light source of module of claim 31, wherein a coupler to be coupled to a heat sink is provided at the second region.
